(19) United States
(12) Patent Application Publication
(10) Pub. No.: US 2016/0034889 A1
(43) Pub. Date: Feb. 4, 2016

(54) APPARATUS, METHOD, AND COMPUTER PROGRAM PRODUCT FOR AUTOMATED SEQUENTIAL ELECTRONIC PAYMENTS

(71) Applicant: MasterCard International Incorporated, Purchase, NY (US)

(72) Inventors: Edward F. Downs, River Vale, NJ (US); Aviva Klein, Toronto (CA); Robert A. Snyder, Monsey, NY (US)

(21) Appl. No.: 14/661,982

(22) Filed: Mar. 18, 2015

Related U.S. Application Data
(60) Provisional application No. 62/030,479, filed on Jul. 29, 2014.

(51) Int. Cl. G06Q 20/34; G06Q 20/38; G06Q 30/06

(52) U.S. Cl. CPC G06Q 20/351; G06Q 30/0613; G06Q 20/382

(57) ABSTRACT

In a scenario where a buyer purchases at least one of goods and services from a seller via an intermediary, at at least one of the intermediary and a third party, an indication is obtained that payment to the intermediary from the buyer is appropriate. Responsive to the indication, the at least one of the intermediary and the third party initiates a pull payment, via a payment card network, for an on-file payment card account number of the buyer. Responsive to success of the pull payment, the at least one of the intermediary and a third party initiates a push payment to the seller.

### CROSS-REFERENCE TO RELATED APPLICATIONS

This patent application claims the benefit of U.S. Provisional Patent Application Ser. No. 62/030,479 filed on 29 Jul. 2014 and entitled “APPARATUS, METHOD, AND COMPUTER PROGRAM PRODUCT FOR AUTOMATED SEQUENTIAL ELECTRONIC PAYMENTS.” The complete disclosure of the aforementioned U.S. Provisional Patent Application Ser. No. 62/030,479 including all appendices thereof is expressly incorporated herein by reference in its entirety for all purposes.

### FIELD OF THE INVENTION

The present invention relates generally to the electronic and computer arts, and, more particularly, to electronic payment techniques and the like.

### BACKGROUND OF THE INVENTION

Currently, the majority of payments between buyer and seller which pass through an intermediary are settled via paper check and have a significant time lag and a long settlement period. Time lags in payments are realized because both buyers and intermediaries want to preserve working capital, generally at the expense of suppliers who bear additional cost in financing the receivables, combined with requirements for getting paid before making payment.

### SUMMARY OF THE INVENTION

Principles of the present invention provide techniques for automated sequential electronic payments. In one aspect, an exemplary method for automating sequential electronic payments, in a scenario where a buyer purchases at least one of goods and services from a seller via an intermediary, according to an aspect of the invention, includes the steps of obtaining, at at least one of the intermediary and/or a third party, an indication that payment to the intermediary from the buyer is appropriate. Responsive to the indication, the intermediary and/or third party initiates a pull payment, via a payment card network, for an on-file payment card account number of the buyer. Responsive to success of the pull payment, the intermediary and/or third party initiates a push payment to the seller.

Aspects of the invention contemplate the method(s) described herein performed by one or more entities herein, as well as facilitating of one or more method steps by the same or different entities. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a tangible computer readable recordable storage medium with computer usable program code for performing the method steps indicated stored thereon in a non-transitory manner. Furthermore, one or more embodiments of the invention or elements thereof can be implemented in the form of a system (or apparatus) including a memory and at least one processor that is coupled to the memory and operative to perform exemplary method steps (e.g., when instructions from a persistent storage device are loaded into the memory to configure the processor). Yet further, in another aspect, one or more embodiments of the invention or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein. Transmission medium(s) per se and disembodied signals per se are defined to be excluded from the claimed means.

One or more embodiments of the invention can provide substantial beneficial technical effects, as will be appreciated by the skilled artisan from the discussion herein. For example, embodiments employing virtual card numbers provide increased security and/or reduce PCI requirements to the merchant and potentially the issuer as well.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows an example of a system and various components thereof that can implement at least a portion of some techniques of the invention;

FIG. 2 depicts an exemplary inter-relationship between and among: (i) a payment network configured to facilitate transactions between multiple issuers and multiple acquirers, (ii) a plurality of users, (iii) a plurality of merchants, (iv) a plurality of acquirers, and (v) a plurality of issuers, useful in connection with one or more embodiments of the invention;

FIG. 3 shows exemplary operation of a bill pay system, as known from the prior art;

FIG. 4 shows exemplary operation of current automated clearinghouse payments;

FIG. 5 is a process flow diagram showing a payment process in accordance with the prior art;

FIG. 6 is a process flow diagram showing a payment process in accordance with an aspect of the invention;

FIG. 7 is a block diagram of an exemplary computer system useful in one or more embodiments of the invention;

FIG. 8 is an exemplary software architecture diagram, in accordance with an aspect of the invention;

FIGS. 9 and 10 provide an exemplary detailed view of operation of a payment card network, in accordance with an aspect of the disclosure;

FIG. 11 shows a group of payment network interface processors, such as may be used with the network of FIGS. 9 and 10;

FIG. 12 shows a port arrangement on a payment network interface processor, such as may be used with the network of FIGS. 9 and 10; and

FIG. 13 shows a case wherein an issuer has multiple payment network interface processors.

### DETAILED DESCRIPTION OF PREFERRED EMBODIMENTS

### Payment Devices and Associated Payment Processing Networks

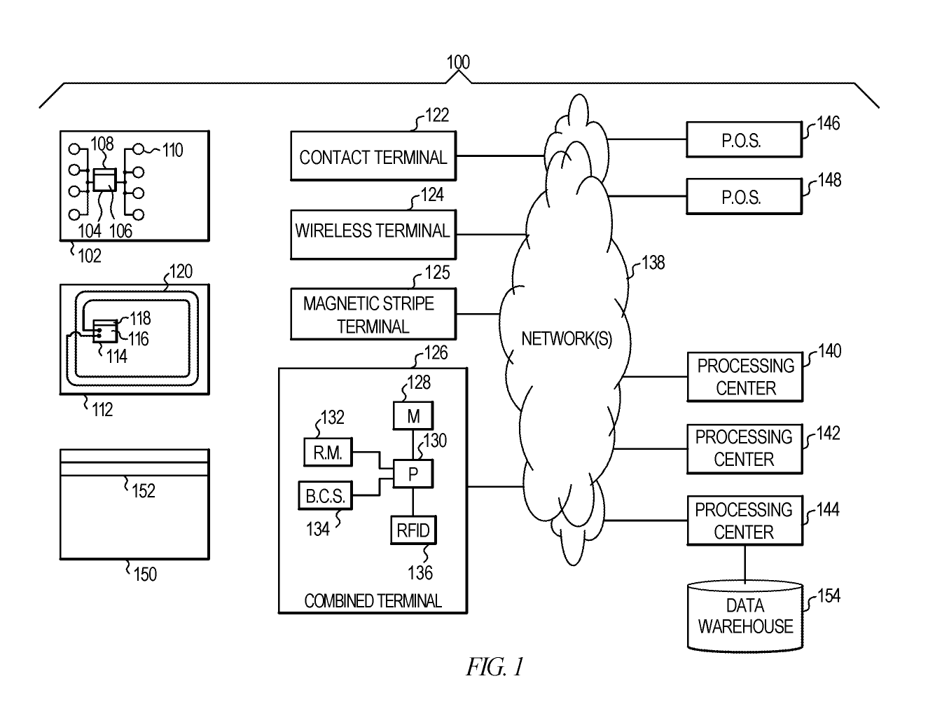

With regard to payment card and similar payments, attention should now be given to FIG. 1, which depicts an exemplary embodiment of a system 100, according to an aspect of the invention, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed. The system 100 typically functions with other types of devices in lieu of or in addition to “smart” or “chip” cards 102, 112; for example, a conventional card 150 having a magnetic stripe 152. Furthermore, an appropriately configured mobile device (e.g., “smart” cellular telephone handset, tablet, personal digital assistant (PDA), and the like) can be used to carry out contactless payments in some instances; for example, via near field communications (NFC), wherein the appropriately configured mobile device acts like a contactless card 112 (or, with an electronic wallet present, like multiple such cards).

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions of units 108, 118 can store the operating system of the cards 102, 112. The operating system loads and executes applications and provides file management or other basic card services to the applications. One operating system that can be used to implement some aspects or embodiments of the present invention is the MULTOS® operating system licensed by MAOSCO Limited. (MAOSCO Limited, St. Andrews House, The Links, Kelvin Close, Birchwood, Warrington, Wash. 3 7PB, United Kingdom) Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that applications can be configured in a variety of different ways.

The skilled artisan will also be familiar with the MasterCard® PayPass™ specifications, available under license from MasterCard International Incorporated of Purchase, N.Y., USA (marks of MasterCard International Incorporated of Purchase, N.Y., USA).

As noted, cards 102, 112 are examples of a variety of payment devices that can be employed. The primary function of the payment devices may not be payment, for example, they may be cellular phone handsets that implement appropriate techniques. Such devices could include cards having a conventional form factor, smaller or larger cards, cards of different shape, key fobs, personal digital assistants (PDAs), appropriately configured cell phone handsets, or indeed any device with the appropriate capabilities. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to execute one or more steps. The applications can be, for example, application identifiers (AIDs) linked to software code in the form of firmware plus data in a card memory such as an electrically erasable programmable read-only memory (EEPROM).

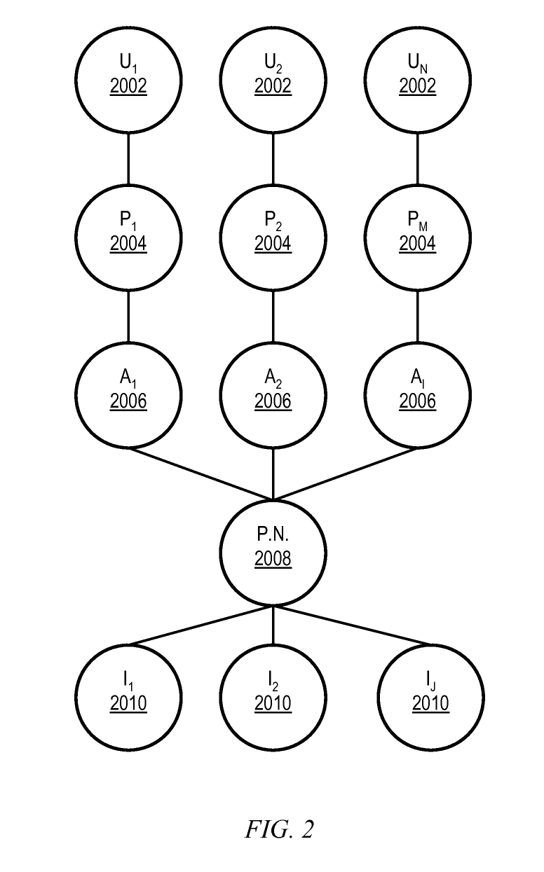

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any combination of devices 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can, in general, be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (e.g., a virtual private network (VPN) such as is described with respect to FIG. 2 below). More than one network could be employed to connect different elements of the system. For example, a local area network (LAN) could connect a terminal to a local server or other computer at a retail establishment or the like. A payment network could connect acquirers and issuers. Further details regarding one specific form of payment network will be provided below. Processing centers 140, 142, 144 can include, for example, a host computer of an issuer of a payment device.

Many different retail or other establishments, represented by points-of-sale 146, 148, can be connected to network 138. Different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone, tablet, or the like.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses 102, 112, 150. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can optionally be provided, and can be coupled to the processor, to gather attribute data, such as a product identification, from a UPC code or RFID tag on a product to be purchased.

The above-described devices 102, 112 can be ISO 7816-compliant contact cards or devices or NFC (Near Field Communications) or ISO 14443-compliant proximity cards or devices. In operation, card 112 can be touched or tapped on the terminal 124 or 128 (or an associated reader), which then contactlessly transmits the electronic data to the proximity IC chip in the card 112 or other wireless device.

One or more of the processing centers 140, 142, 144 can include a database such as a data warehouse 154.

For completeness, it should be noted that the system depicted in FIG. 1 may involve not only conventional transactions at “brick and mortar” merchants, but also, card-not-present transactions, such as card-not-present Internet transactions or card-not-present recurring payments. In some instances, an Internet Protocol (IP) address may be captured during card-not-present Internet transactions. In exemplary card-not-present Internet transactions, an individual utilizes his or her home computer to communicate with a server of an e-commerce merchant over the Internet. The individual provides his or her PAN to the merchant's server. The merchant utilizes the PAN to initiate an authorization request, and upon receiving an authorization request response indicating approval, will complete the e-commerce transaction. In exemplary card-not-present recurring payments, an individual provides his or her PAN and related data to a merchant (e.g., via phone or postal mail). The merchant utilizes the PAN to initiate an authorization request, and upon receiving an authorization request response indicating approval, will complete the recurring transaction.

In some cases, there can be payment card accounts which do not have physical cards or other physical payment devices associated therewith; for example, a customer can be provided with a PAN, expiration date, and security code but no physical payment device, and use same, for example, for card-not-present telephone or internet transactions. In this regard, a “cardholder” should be understood to refer to the account holder of a payment card account, regardless of whether the holder actually has a physical payment card or other physical payment device.

With reference to FIG. 2, an exemplary relationship among multiple entities is depicted. A number of different users (e.g., consumers) 2002, U₁, U₂ . . . U_{N}, interact with a number of different merchants 2004, P₁, P₂ . . . P_{M}. Merchants 2004 interact with a number of different acquirers 2006, A₁, A₂ . . . A_{I}. Acquirers 2006 interact with a number of different issuers 2010, I₁, I₂ . . . I_{J}, through, for example, a single operator 2008 of a payment network configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal. Note also that elements 2006, 2010 represent the entities that actually carry out processing for the acquirers and issuers respectively; in some instances, these entities carry out their own processing; in other entities, they utilize acquirer processors and issuer processors, respectively.

During a conventional credit authorization process, the cardholder 2002 pays for the purchase and the merchant 2004 submits the transaction to the acquirer (acquiring bank) 2006. The acquirer verifies the card number, the transaction type and the amount with the issuer 2010 and reserves that amount of the cardholder's credit limit for the merchant. At this point, the authorization request and response have been exchanged, typically in real time. Authorized transactions are stored in “batches,” which are sent to the acquirer 2006. During subsequent clearing and settlement, the acquirer sends the batch transactions through the credit card association, which debits the issuers 2010 for payment and credits the acquirer 2006. Once the acquirer 2006 has been paid, the acquirer 2006 pays the merchant 2004.

It will be appreciated that the network 2008 shown in FIG. 2 is an example of a payment network configured to facilitate transactions between multiple issuers and multiple acquirers, which may be thought of as an “open” system. Some embodiments of the invention may be employed in relation to payment card accounts using other kinds of payment networks, for example, proprietary or closed payments networks with only a single issuer and acquirer. Furthermore in this regard, FIG. 2 depicts a four party model, as will be known to the skilled artisan; the four parties are the consumer 2002, merchant 2004, acquirer 2006, and issuer 2010. However, at least some embodiments are also of use with three-party models, wherein the acquirer and issuer are the same entity.

Messages within a network such as network 138 and/or network 2008, may, in at least some instances, conform to the International Organization for Standardization (ISO) Standard 8583, Financial transaction card originated messages—Interchange message specifications, which is the ISO standard for systems that exchange electronic transactions made by cardholders using payment cards. It should be noted that the skilled artisan will be familiar with the ISO 8583 standards. Nevertheless, out of an abundance of caution, the following documents are expressly incorporated herein by reference in their entirety for all purposes (published by ISO, Geneva, Switzerland, and available on the ISO web site):
ISO 8583 Part 1: Messages, data elements and code values (2003)
ISO 8583 Part 2: Application and registration procedures for Institution Identification Codes (IIC) (1998)
ISO 8583 Part 3: Maintenance procedures for messages, data elements and code values (2003)
ISO 8583:1993 (1993)
ISO 8583:1987 (1987)

As used herein, a “payment card network” is a communications network that uses payment card account numbers, such as primary account numbers (PANs), to authorize, and to facilitate clearing and settlement of, payment card transactions for credit, debit, stored value and/or prepaid card accounts. The card accounts have standardized payment card account numbers associated with them, which allow for efficient routing and clearing of transactions; for example, ISO standard account numbers such as ISO/IEC 7812-compliant account numbers. The card accounts and/or account numbers may or may not have physical cards or other physical payment devices associated with them. For example, in some instances, organizations have purchasing or procurement card accounts to which a payment card account number is assigned, used for making purchases for the organization, but there is no corresponding physical card. In other instances, “virtual” account numbers are employed; this is also known as PAN mapping. The PAN mapping process involves taking the original Primary Account Number (PAN)(which may or may not be associated with a physical card) and issuing a pseudo-PAN (or virtual card number) in its place. Commercially available PAN-mapping solutions include those available from Orbiscom Ltd., Block 1, Blackrock Business Park, Carysfort Avenue, Blackrock, Co. Dublin, Ireland (now part of MasterCard International Incorporated of Purchase, N.Y., USA); by way of example and not limitation, techniques of U.S. Pat. Nos. 6,636,833 and 7,136,835 of Flitcroft et al., the complete disclosures of both of which are expressly incorporated herein by reference in their entireties for all purposes.

Some payment card networks connect multiple issuers with multiple acquirers; others use a three party model. Some payment card networks use ISO 8583 messaging. Non-limiting examples of payment card networks that connect multiple issuers with multiple acquirers are the BANKNET® network and the VISANET® network. One or more embodiments are applicable to many other different kinds of payment card networks as well; the AMERICAN EXPRESS® network and the DISCOVER® network are non-limiting examples.

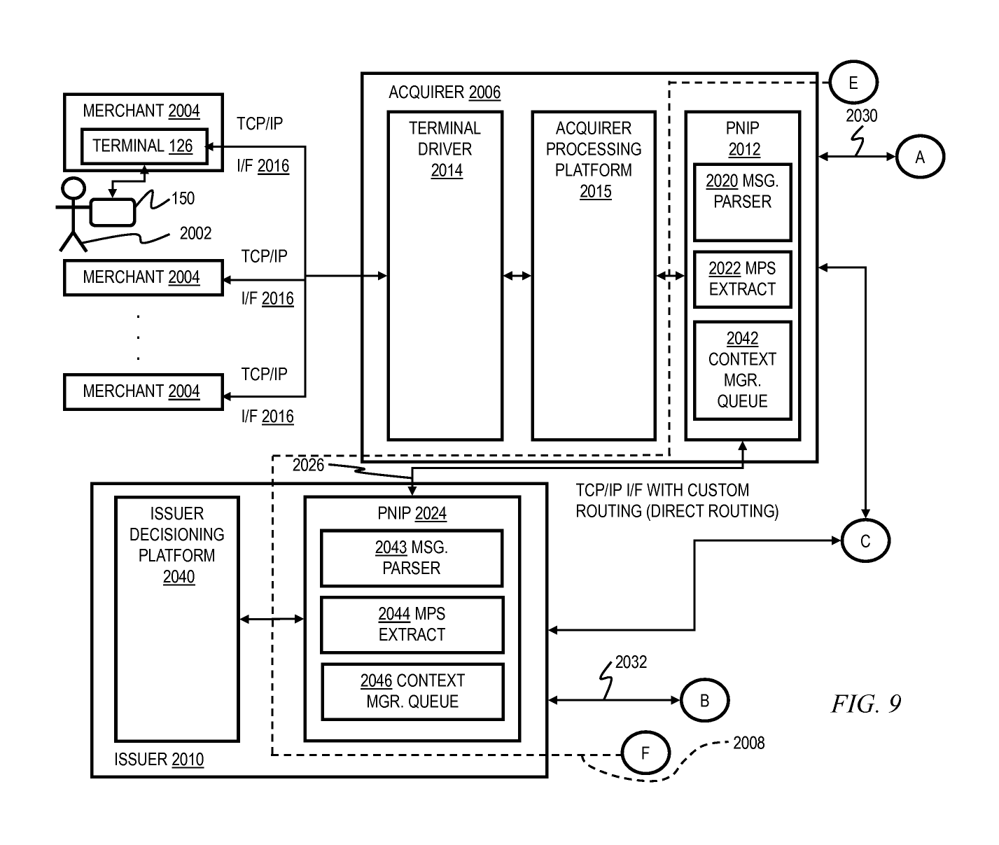

Still referring to FIG. 2, and with reference also now to FIGS. 9 and 10, by way of review and provision of additional detail, a consumer 2002 effectively presents his or her card 150 or other payment device (e.g., presents suitably configured “smart” phone or uses an e-wallet) to the terminal 126 of a merchant 2004. A mag stripe card 150 and combined terminal 126 are shown by way of example, but are intended to generally represent any kind of payment device and any kind of terminal. The effective presentation can happen directly (user enters a brick and mortar location of a merchant 2004) or virtually (user logs on to a web site of a merchant 2004 via a browser of a personal computer or the like, or calls on the telephone, and provides card information, or sends a “snail” mail with payment card account information to a hospital or other inpatient treatment facility). The merchant terminal 126 captures the card account information (by swiping or wireless communication if directly presented; by manual keying or reading data if remote) and forwards same to the acquirer 2006. Interaction between the merchant and cardholder is outside the purview of the payment card network per se. The payment card network becomes involved at the connection between the acquirer 2006 and network 2008; the dotted line between points E and F in FIGS. 9 and 10 encompasses the network 2008. Note generally that points A, B, C, E, and F in FIG. 9 connect to the corresponding points in FIG. 10; the entire network and associated environment are not amenable to illustration on a single sheet.

More specifically, the acquirer 2006, in the more specific example of FIGS. 9 and 10, has at its premises a payment network interface processor (PNIP 2012). The MasterCard Interface Processor or MIP is a non-limiting example of a PNIP. In a non-limiting example, the PNIP is implemented on a rack-mounted server. PNIPs are typically located at the edges of the payment card network. In at least some instances, the payment card network of FIG. 2 is a distributed network wherein each acquirer and issuer has at least one PNIP on their premises. Each acquirer 2006 will have a relationship with one or more merchants 2004 and will interface with the merchants' terminals 126 via terminal driver 2014 (an acquirer may also act as an acquirer for themselves as a merchant). Furthermore in this regard, the merchant locations will have terminals where the cards are swiped (or where contacted or contactless devices are presented). The acquirer will employ terminal driver 2014 to interface with those terminals. Terminal driver 2014 is a logical block representing software and/or hardware that allows the acquirer processing platform 2015 to communicate with the terminals of the merchants via TCP, dial up, or the like (TCP/IP interfaces 2016 are shown in the example in the figures). Each merchant will decide what acquirer to use to accept one or more brands of payment cards, and the acquirer will set the merchant up with the appropriate software and/or firmware for the merchant's point of sale devices.

The acquirer 2006 will present transactions from many different merchants 2004 to the payment card network operator 2008 via the PNIP interface 2012. The connection between the merchants 2004 and the acquirer 2006 is typically a TCP/IP interface 2016. The format that the transaction is in when the card is swiped at the merchant 2004 may differ from the format that the transaction is in when actually received by the payment card network operator. The acquirer may convert the transaction into the ISO 8583 format or into a format that is a specific implementation of the ISO 8583 format (e.g., the MASTERCARD CIS (customer interface specification) format. The authorization request message can be an ISO 8583 message type identifier (MTI) 0100 message, for example, sent over the communications interface 2016 between the merchant 2004 and the acquirer 2006.

Once the 0100 message is received at the PNIP 2012 of the acquirer 2006, a series of edits can be performed on the transaction with respect to format, content, and/or context. Furthermore, screening can be carried out to determine whether the message relates to something beyond an ordinary authorization request, referred to as an enhanced service. Enhanced services may be screened for on behalf of one or more issuers 2010 and/or the operator of network 2008 itself. A centralized member parameter system (MPS) 2018 can be provided to house parameters used to drive processing of credit authorization transactions. In one or more embodiments, extracts from the centralized member parameter system 2018 are distributed to all acquirer PNIPs 2012 and issuer PNIPs 2024 on the network 2008 on a daily basis to drive processing of credit card transactions.

It should be noted at this point that an “ICA” and a “BIN” are employed in BANKNET so that a member can perform card issuing and/or acquiring activities. An ICA or Interbank Card Association is a four to six digit identification assigned by MasterCard for use by a member to uniquely identify activity the member is responsible for. A BIN or Bank Identification Number is a unique series of numbers assigned by MasterCard to a principal member and used as the first six digits of a cardholder account number. Other payment card networks have similar types of numbers, as will be apparent to the skilled artisan.

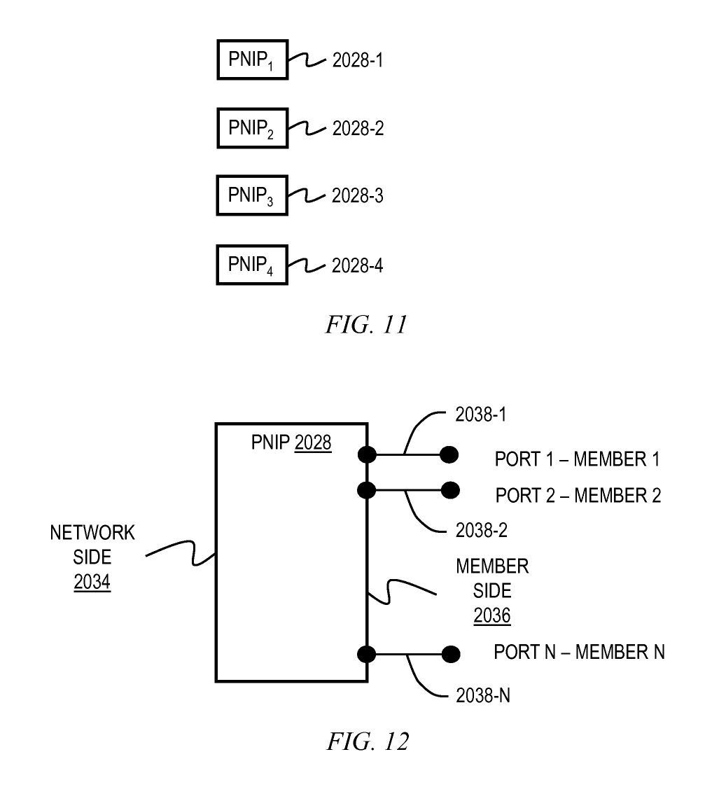

In at least some embodiments, the same member parameter extract is sent to all PNIPs and transactions are routed using same. In at least some circumstances, account numbers or ranges of account numbers are used in deciding how to route. In some cases, transactions are routed to an issuer PNIP based on where the account range is “signed in.” Issuers send an MTI 0800 sign in request message with either a group ID or account range. The Member ID is pulled from the PNIP port 2038 configuration and transactions from that account range are then routed to the port from which the sign-in request is received. A member ID can be present on ports on multiple PNIPs at an Issuer site—see discussion of FIG. 12 below.

In one or more embodiments, based on the account range, the parameters in MPS 2018 (or a local extract thereof) will determine how to process a given transaction; e.g., product code, country code, currency code, and the like, including what enhanced services (if any) the issuer has signed up for on a particular account range. That is to say, the messages are parsed and certain fields, including the account range, are examined; the account range is associated with a certain issuer and based on that, the message may be treated differently. Messages may be parsed, and converted into an internal data format so that access can be obtained to all the individual data elements. In one or more embodiments, the account number is used as a key to access the MPS 2018 (or a local extract thereof) and retrieve all the parameters that are appropriate for processing the given transaction. In a non-limiting example, a suitable message parser 2020 (and other programs on the PNIP 2012) can be written in an appropriate high-level language or the like.

In an exemplary embodiment, the central MPS 2018 creates extracts once a day that are distributed out to the endpoints on the network (e.g., PNIPs 2012), as seen at 2022. These extracts include the pertinent information needed for the PNIP to process the message and determine if it requires any special handling. In some instances, messages are next routed to a central site 2009 for performance of enhanced services. On the other hand, if no special services are required, the message may be routed directly to the issuer PNIP 2024 as seen at 2026.

Messages routed directly to the issuer PNIP: In this aspect, the transaction is routed directly to the issuer PNIP 2024 based on the MPS extract 2022, as seen at 2026. Every account range will have a unique destination endpoint identified in the parameters (account ranges may be grouped and all members of the account range group may have a common destination endpoint). The member interface refers to the connection between the acquirer processor 2006 and the Acquirer PNIP 2012. This term also applies to the interface between the Issuer PNIP 2024 and issuer processor 2010. The connections between and among acquirer PNIP 2012 and issuer PNIP 2024, acquirer PNIP 2012 and ASPs 2050, and ASPs 2050 and issuer PNIP 2024 are referred to as a network interface onto the payment card network itself. In one or more embodiments, this may be a TCP/IP connection (as seen at 2026) with customized routing capabilities including group addresses. Normally, TCP/IP addresses refer to a single endpoint. Group addresses may be directed to a group of addresses, and will target any of the computers (e.g., PNIPs) in the group using a variety of protocols. Some use a round robin approach; others may use a first in list approach where the message is always routed to one given computer first and then to a second computer only if the first is not available. Group addressing may be useful, for example, where an acquirer or issuer has multiple PNIPS at the same location for redundancy/fault tolerance. It is also possible to combine the approach and institute a round robin, wherein the addresses within the round robin are first in list group address, or conversely, it is possible to institute a first-in-list, wherein the addresses within the first-in-list are round robin group addresses. These capabilities are useful in case of outages, maintenance, and the like.

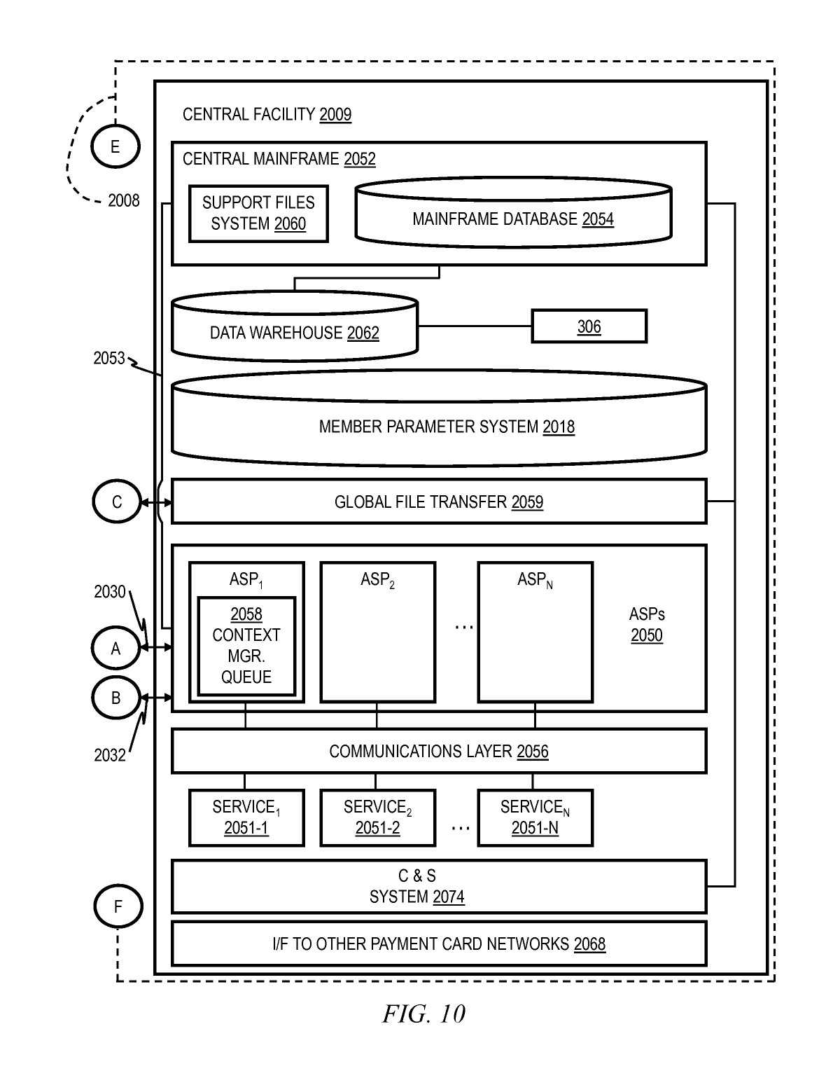

FIG. 11 shows a non-limiting example with four PNIPs 2028-1 through 2028-4. In a round robin approach, a first message is routed first to PNIP 2028-1, a second message to PNIP 2028-2, a third message to PNIP 2028-3, a fourth message to PNIP 2028-4, a fifth message to PNIP 2028-1, and so on. In a first in list approach, all messages are routed to PNIP 2028-1; if it is not available for a given message, the message is routed to PNIP 2028-2; if PNIP 2028-2 is not available, the message is routed to PNIP 2028-3; if PNIP 2028-3 is not available, the message is routed to 2028-4. Each PNIP 2028-1 through 2028-4 in FIG. 11 could be a single machine or a group of machines addressed by first in list or round robin as discussed just above. In one or more embodiments, the physical network 2026 between PNIPs 2012, 2024 and the physical network 2030, 2032 between PNIPs 2012, 2024 and the central site 2009 is a private Multiprotocol Label Switching (MPLS) TCP/IP network and is not the Internet. Once the issuer's network group address has been determined by the PNIP 2012 (or ASP 2050), the message is routed to the issuer PNIP 2024. Once the 0100 auth message arrives at the issuer PNIP 2024, additional edits are performed to double check and make sure that the message has been routed to the correct location. Furthermore, the member ID is examined, because some issuers may share a single PNIP and it is necessary to determine which of the issuers (members) sharing that PNIP the transaction in question is to be routed to. Each of the issuers sharing the PNIP will have its own port on the member side of the PNIP; the transaction is routed to the appropriate port based on the member parameters. See FIG. 12 where a generalized PNIP 2028 has a network side 2034 and a member side 2036. Member side 2036 has N ports 2038-1 through 2038-N to members 1 to N. N is used herein as a generalized arbitrary integer and the value of N in FIG. 12 is not necessarily the same as that of N in connection with elements 2002 in FIG. 2, for example.

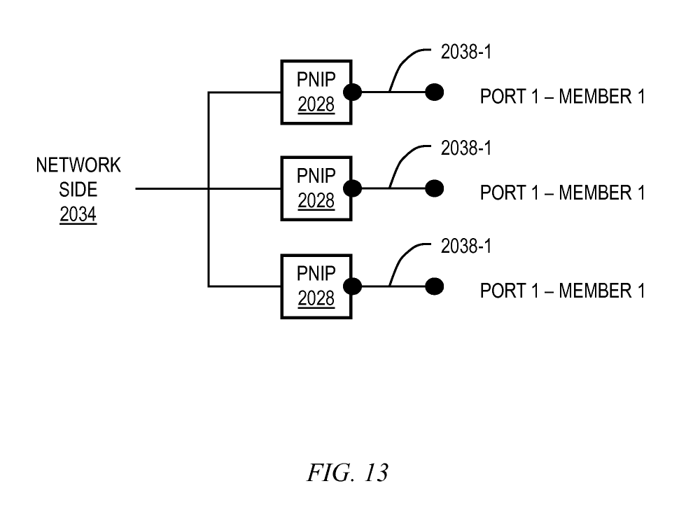

As seen in FIG. 13, in some instances, an issuer has multiple PNIP devices 2028 at a single site, with a network-side connection 2034, and with multiple PNIPs 2028 all connected to the same host system (each has port 1 2038-1 associated with the same member (issuer)).

At this point, the 0100 message has been delivered to the issuer 2010. The issuer 2010 then carries out issuer processing and decisioning (e.g., with issuer processing platform 2040) based on transaction velocities, open to buy, fraud detection protocols, etc., and provides an appropriate authorization request response, ISO 8583 MTI 0110. There are a number of different possible response codes defined within ISO 8583 and its particular implementations. Each transaction is made up of multiple data elements; the response from the issuer is included in data element 39. Once the 0110 message is received on the issuer PNIP 2024 from platform 2040 it is parsed and edited for format, content, and context, including validation of DE39 to make sure that it is a valid value.

It is worth noting that in one or more instances, at every point where a transaction touches a computer of the payment card network, whether it be an acquirer PNIP 2012, issuer PNIP 2024, or a special services computer or computers 2050 at the central location 2009 (discussed below), transaction context is preserved. That is to say, before the message is sent on to the next node in the network, a copy is saved in a context manager queue 2042, 2046, 2058, so that when the transaction response MTI 0110 comes back through, the request MTI 0100 can be matched with the response, in order to know how to route the response back to the previous route point. One of the items saved in the context manager queue is the message originator's address, so that it can be used for route-back information. Once the issuer PNIP validation is complete, including format, content, and context edits, the transaction is extracted from the context manager queue 2046 and the route-back address is retrieved, and the 0110 message is then sent back where it came from; in this case, the acquirer PNIP 2012 (or ASP 2050). The acquirer PNIP 2012 then receives and parses the message and pulls its original request out of its context manager queue 2042. Note that multiple acquirers may share an acquirer PNIP and it is therefore necessary to know which port on the acquirer PNIP to route the response back to (see discussion of FIG. 12). Checking the message against the original request in the context manager queue allows the message to be routed back to the correct port.

Each PNIP 2012, 2024 typically has many different programs. These can include, for example, a parser/editor 2020, 2043; a parameter file manager; a transaction context manager; a member communications program; a network communications program; and the like. Please note that to reduce clutter, FIGS. 9 and 10 show “MPS extract” 2022, 2044; this will typically include the extract itself and the associated parameter file manager which manages obtaining the extracts from MPS 2018. Similarly, to reduce clutter, FIGS. 9 and 10 show “context manager queue” 2042, 2046; this will typically include the queue itself and the associated manager which manages the contents of the queue. In one or more embodiments, there is also a communication program used to communicate between the other programs (inter-process communications) on the PNIP; this is omitted from FIGS. 9 and 10 to avoid clutter.

Messages in case of Enhanced Services: In one or more instances, a special architecture is used to facilitate delivery of enhanced services (the ASP 2050 in FIGS. 9 and 10 is a non-limiting example). Examples of enhanced services include the MasterCard “inControl” product providing spending controls and/or virtual card numbers. Other examples are loyalty rewards, recurring payment cancellations, and the like. One or more instances do not deploy this complex logic out to the network edge. Furthermore in this regard, the issuer and acquirer PNIPs 2012, 2024 are referred to as being on the edge because they reside on the customer's premises 2006, 2010. There may be over 2000 PNIPs on a typical network. The special architecture used in one or more instances is a central site type architecture associated with location 2009. At the central site 2009, certain computers are referred to as authorization services processors or ASPs 2050.

On the acquirer PNIP 2012, when checking the member parameter file for an account range, determine whether the transaction requires enhanced services. If yes, the transactions is routed to the central site ASPs 2050, which have interfaces to all of the service provider systems—the ASPs do not necessarily provide the services themselves (although they can in some embodiments), but may mediate between the network (e.g., BANKNET) and the actual service providers 2051-1 through 2051-N. An ASP will typically have connections 2053 to a mainframe 2052 via DB2 connect or other suitable connection. If a transaction is to be enriched with additional data, a database call will be made to the mainframe 2052 to retrieve the information from mainframe database 2054 so that it can be inserted into the transaction before the transaction is forwarded to the issuers. Interfaces can also be provided to a risk management system, a decisioning management system, IN CONTROL, rewards, and the like. Service providers 2051-1 through 2051-N generally represent any enhanced services, non-limiting examples of which have been given herein.

A communications layer 2056 is used to communicate with the service providers in one or more embodiments, a non-limiting example of a suitable implementation is the IBM MQ series. The 0100 message may be sent to the service providers, optionally encapsulated inside a special “enhanced services” (ES) header that wraps the message with any additional information required to fulfill the service. The service provider sends a response. The ASP takes the response and enriches the 0100 transaction with the service response, and then sends the entire package on to the issuer PNIP 2024. Some enhanced services are processed on the request messages (0100) and others are processed on the response messages (0110). Once the response message is processed on the ASP, the original message will be pulled from the context manager queue 2058 on the ASP to determine the appropriate acquirer PNIP 2012 to route the message back to. From there, the acquirer PNIP will behave just as in the “Messages routed directly to the issuer PNIP” case discussed above. Some embodiments of the special architecture use an Enterprise Service Bus to mediate and facilitate some of the services 2051. For example, the In CONTROL service can be accessed via an instance of an Enterprise Service Bus.

Entry of Data into the Data Warehouse: In one or more instances, every transaction that flows through the issuer PNIP 2012, acquirer PNIP 2024, and/or ASPs 2050 is logged at every point by writing log records. Multiple times a day (e.g., six), a global file transfer system 2059 pulls the logs off each node and collects them into a support files system 2060 on the mainframe 2052. The log files are parsed and collected into a general daily file. The general daily file is scrubbed and modified to create a consolidated file on the mainframe which is then pulled into the data warehouse 2062, where additional data manipulation and scrubbing are performed before the transactions are stored. The data warehouse 2062 is located at an intermediate node (location 2009) connected to the PNIPs of the acquirers and issuers 2012, 2024. By way of clarification, in one or more embodiments, the node 2009 is directly connected to the PNIPs 2012, 2024 but the data warehouse is not directly connected to the 2012 and 2024 devices; rather, data flows through GFT and SF systems 2059, 2060 and ends up in the data warehouse. Data warehouse 2062 should be distinguished from a data warehouse 154 that might be maintained by an issuer.

Clearing and Settlement: One or more instances employ a clearing and settlement system 2074. In clearing, via global file transfer 2059, acquirers submit clearing files in an appropriate message format (in a non-limiting example, Integrated Product Messages (IPM) format). The files contain, from the acquirers' perspective, what they believe they should be paid for. In one or more instances, the authorization does not actually move any money; the authorization only validates that the cardholder is a valid cardholder recognized by the bank, which will honor payment to the merchant for the goods or services. For example, in a typical restaurant visit, the card is swiped for the receipt amount but then a tip is added. The clearing message will have the actual food amount plus the tip. In one or more instances, the clearing does not actually move the money; it merely resolves the actual amounts. The settlement system actually initiates movement of the money. Furthermore in this regard, the settlement system actually tells the banks how much money to move but does not actually move the money. Within clearing, processes include dispute resolution, chargeback, and the like. During clearing, files are sent from the acquirers to the payment card network; the payment card network, using clearing and settlement system 2074, then takes the files and splits them and sorts them by issuer. Response files are then received from each issuer, and these response files are again split and re-sorted back to the correct acquirers. Eventually, data flows into the settlement system and money is moved. Thus, at a high level, the auth request and auth request response are in real time, and the clearing and settlement are in a batch mode.

By way of review and provision of additional detail, in at least some instances, in a batch mode, clearing is initiated via an ISO 8583 MTI 1240 message having a DE24 function code value of 200 for a first presentment. Once this message is obtained from the acquirer, the payment card network, using clearing and settlement system 2074, will undertake syntax edits, format edits, content edits, and context edits (typically applied to every transaction). If those edits are passed, the interchange and fees associated with the transaction will be calculated. Based on the calculations, the message may also be enriched with additional information before being passed on to the issuer. The settlement amount is then determined. Within the clearing cycle, the amounts of money due to each given member (e.g., issuer or acquirer) are accumulated, and these are summed up into a settlement file which is forwarded in due course.

Cryptographic aspects: Consider the concepts of data at rest and data in motion. An example of data at rest is the log files that actually reside on the PNIPS themselves—configuration information containing card numbers or personally identifiable information (PII). In one or more embodiments, all sensitive data at rest is encrypted before being written to disk. Data in motion refers to data actually moving over a transmission medium (e.g., wires, coaxial cable, fiber optic cable, RF link). All PCI-sensitive data (PCI Security Standards Council, LLC, Wakefield, Mass. US) is encrypted, whether written to disk or being sent over a network. In at least some instances, internal links within the premises of the acquirers and issuers are not encrypted since it is assumed that the customer premises are a physically secure facility relying on physical security of the hardware. On the other hand, in at least some instances, external links (e.g., links 2026, 2030 and 2032) are all encrypted for both authorization traffic and bulk file transfers.

One or more embodiments will have interface(s) 2068 to other brands of payment card processing network. For example, a MASTERCARD branded payment card processing network may have interfaces to networks such as AMERICAN EXPRESS, VISA, JCB, DISCOVER, and the like. Suitable translation layers can be provided to intermediate between MASTERCARD (or other) format and formats used by other networks, as appropriate. In one or more embodiments, interfaces 2068 to other payment networks are provided via a machine, located at 2009, but generally analogous to an Issuer PNIP 2024 with added mediation layers loaded as required by other payment network formats. Some merchants may only have a single interface to, e.g., the MASTERCARD network—all transactions from that merchant may be routed to MASTERCARD, regardless of what card was used—MASTERCARD will process those transactions and route them out to the appropriate networks.

While payment card networks have generally been used as described with regard to FIGS. 1 and 2, recently, MasterCard MONEYSEND (mark of MasterCard International Incorporated, Purchase, N.Y., US) money transfer services have provided a new dimension. A funding transaction moves money from the sender (customer) to the Originating Institution (the financial institution providing the money transfer service); that transaction can be initiated through a MONEYSEND application program interface (API). The sender can fund the transaction using a MasterCard card account or other branded card account that the Originating Institution accepts; from a bank account; or with cash. A Payment Transaction transfers funds from the Originating Institution, via the MasterCard Network (e.g., BANKNET), to the payment card account identified by the recipient at the Receiving Institution. Funds can be transferred to a MasterCard® card, Debit MasterCard® card, and the like (marks of MasterCard International Incorporated, Purchase, N.Y., US). Such transactions are discussed further below and are an example of what are more generally referred to herein as special payment transactions.

US Patent Publication 2014-0067620 of Blinov, expressly incorporated herein by reference in its entirety for all purposes, discloses techniques for purchasing by crediting a merchant's card, in connection with an on-line purchase of goods.

Electronic Bill Presentment and/or Payment Systems

The process of electronic bill presentment and payment has also been popular for quite some time. For example, U.S. Pat. No. 5,699,528 to Hogan, expressly incorporated herein by reference in its entirety for all purposes, discloses a system and method for bill delivery and payment over a communications network. In the bill delivery and payment system, users are able to access a server computer on a communications network to obtain bill information and pay bills.

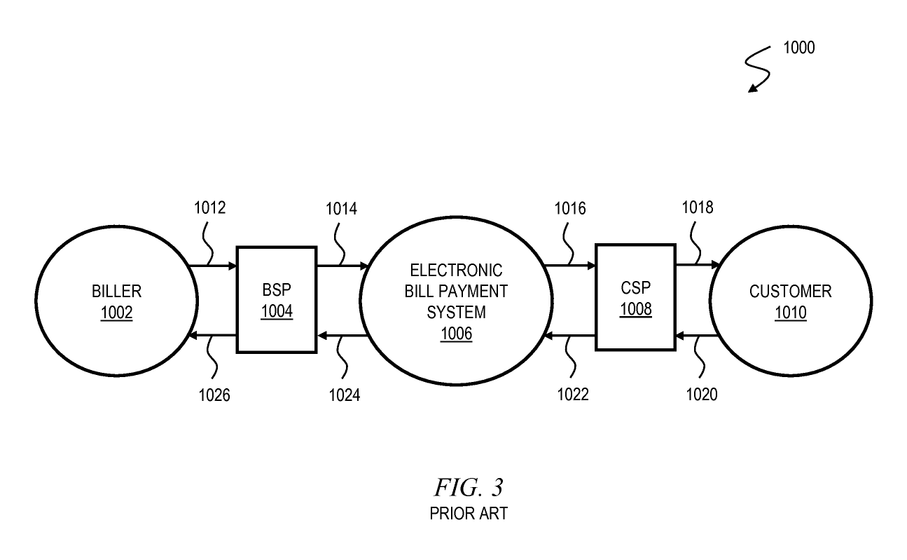

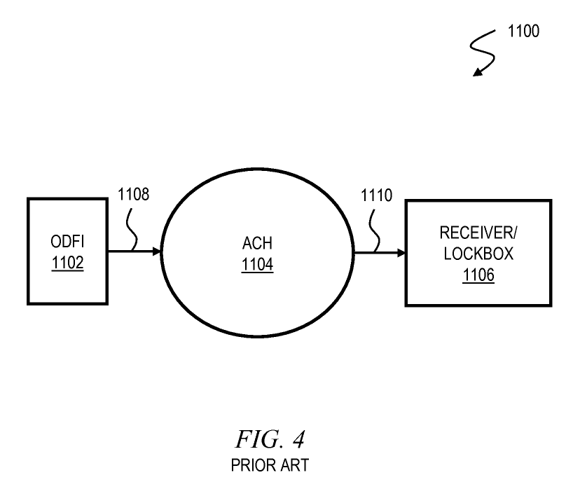

Referring now to FIGS. 3 and 4, electronic bill payment systems are conceptually different than payment card networks, and will often use electronic funds transfer from a demand deposit account. In some instances, a single entity, such as MasterCard International Incorporated (a non-limiting example) will operate both a payment card network and an electronic bill payment system (optionally, with presentment functionality).

Electronic bill presentment and payment systems can be used in connection with some embodiments; one example is the MASTERCARD RPPS® electronic payment system of MasterCard International Incorporated of Purchase, N.Y., USA. This example is non-limiting; for example, other types of electronic bill presentment and/or payment systems could be employed in other instances. Non-limiting examples are described in:
US Patent Publication 2011-0251952 A1 of Mary L. Kelly et al., expressly incorporated herein by reference in its entirety for all purposes.
US Patent Publication 2012-0197788 A1 of Hemal Sanghvi et al., expressly incorporated herein by reference in its entirety for all purposes.
US Patent Publication 2013-0290177 A1 of Amy Christine Milam and Stephen Joseph Klaus, expressly incorporated herein by reference in its entirety for all purposes.
US Patent Publication 2013-0311362 A1 of Amy C. Milam et al., expressly incorporated herein by reference in its entirety for all purposes

For the avoidance of doubt, references to MasterCard, unless expressly stated to be limited to MasterCard, are intended to be exemplary of an operator of an electronic bill payment system (optionally, with presentment functionality), an operator of a payment card network, and/or an operator of a virtual card number generator, as will be appreciated from the context, whether or not qualified by words such as “or other operator.”

Furthermore, another non-limiting example of an electronic bill presentment and/or payment system that could be used in connection with some embodiments of the invention is the CHECKFREE platform available from Fiserv, Inc. of Brookfield, Wis., USA. Other possibilities will also be apparent to the skilled artisan, given the teachings herein.

FIG. 3 shows operation of an electronic bill payment system, such as the MASTERCARD RPPS® electronic payment system, which is but one non-limiting example of such a system. As shown in FIG. 3, in an approach 1000, during a presentment phase, a biller 1002 electronically sends billing information 1012 to its biller service provider (BSP) 1004; that is, an institution that acts as an intermediary between the biller and the consumer for the exchange of electronic bill payment information. BSP 1004 in turn sends the information to the electronic bill payment system 1006, as seen at 1014. As seen at 1016, the system 1006 in turn delivers the billing information to the customer service provider (CSP) 1008, that is, an agent of the customer that provides an interface directly to customers, businesses, or others for bill payment and presentment. The CSP enrolls customers, enables payment and presentment, and provides customer care. CSP 1008 presents the bill to the consumer (customer) 1010 at 1018.

In a payment phase, consumer 1010 sends bill payment instructions to CSP 1008, as seen at 1020. CSP 1008 in turn sends the bill payment information to the system 1006, as at 1022. The system sends funds and data electronically to BSP 1004, as at 1024. The BSP 1004 posts payment information to the biller 1002, as at 1026.

Note that “BPPS” is used herein as shorthand for an electronic “bill presentment and payment system”; the MASTERCARD RPPS system is a non-limiting example of such a system.

Note that in some instances, billers 1002 can connect directly to BPPS 1006 without the use of BSP 1004. In such cases, billers 1002 exchange presentment and payment data directly with BPPS 1006.

FIG. 4 shows a current process 1100 for making electronic funds transfers (EFT) for bill payment or the like. An originating depository financial institution (ODFI) 1102, also known as an originator, sends instructions (e.g., payment data and remittance data) using a network such as the automated clearing house (ACH) 1104, Swift, EPN, CHIPS, Fedwire, and the like, as seen at 1108. As shown at 1110, the ACH or similar network 1104 relays the instructions to the receiving depository financial institution (RDFI) (e.g., receiver or a lockbox), designated 1106. In some embodiments, an ACH file format can be used; non-limiting examples of ACH file formats include the NACHA ACH CIE, NACHA ACH PPD, or NACHA ACH CCD (e.g. for corporate-to-corporate cases) file formats. Other formats can also be used; for example, extensible markup language (XML). It should be noted that a variety of networks can be used, both public (for example, ACH) and proprietary (for example, the aforementioned MASTERCARD RPPS system).

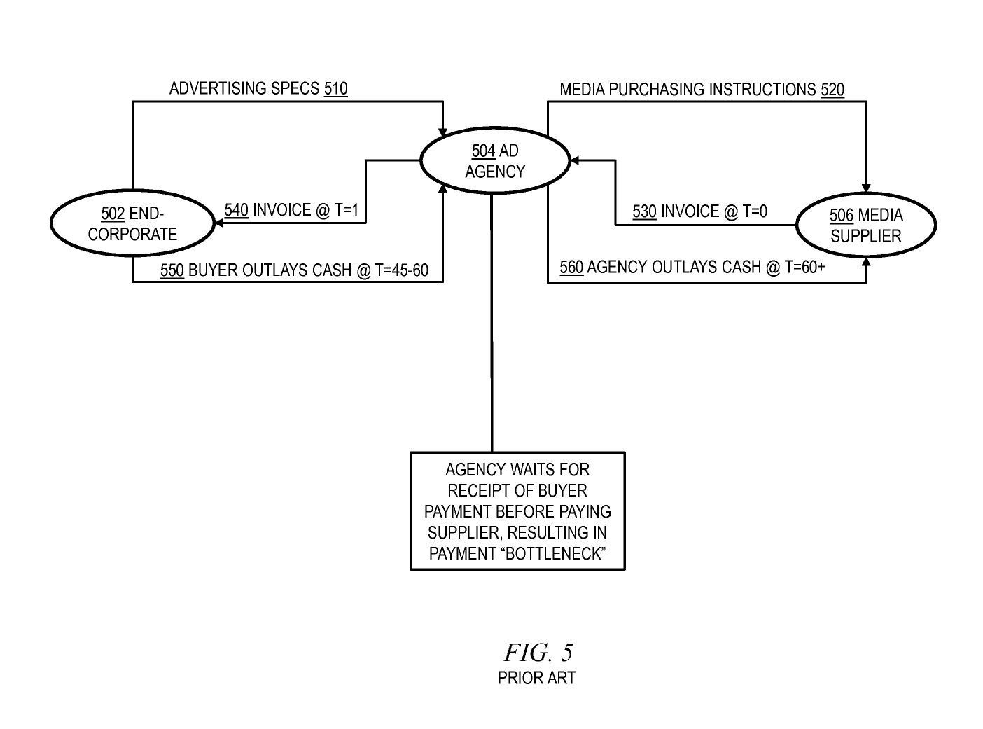

As used herein, an “electronic bill presentment system using customer service providers” refers to a system wherein electronic bills are distributed from billers, through an aggregator switch, out to financial institutions or other customer service providers such that those financial institutions or other customer service providers can display the electronic bills, through the financial institutions' or other customer service providers' own on-line banking interface, to bill-paying customers of the financial institutions or other customer service providers. FIG. 5 of the herein-referenced US Patent Publication 2011-0251952 A1 of Mary L. Kelly et al. shows an exemplary block diagram of an electronic bill presentment system, including a bill payment platform and a bill presentment platform; the bill payment platform may utilize techniques disclosed in the herein-referenced US Patent Publication 2012-0197788 A1 of Hemal Sanghvi et al.

Some electronic bill payment systems use the NACHA ACH Standard Entry Class (SEC) formats, such as CIE (Customer Initiated Entries), CTX (Corporate trade exchange); CCD (Cash Concentration or Disbursement); or PPD (Prearranged payment and deposits). Some electronic bill payment systems use a modified form of the NACHA CIE (MOD-CIE) wherein a payment system operator requires specific values for certain fields. Some electronic bill payment systems (e.g., MASTERCARD RPPS) provide translation capability and can receive input in many different formats, translate it for internal use, and translate it again for output in many different formats, which may be the same as or different from the input formats. Some electronic bill payment systems provide customer service providers with the capability to specify when the electronic bill payment system will look to them for payment instructions. Some electronic bill payment systems provide biller service providers with the capability to specify when the electronic bill payment system will initiate payments. FIG. 5 of the herein-referenced US Patent Publication 2012-0197788 A1 of Hemal Sanghvi et al. shows an exemplary system interfaces of an electronic bill payment system.

As noted above, electronic bill presentment and payment systems are conceptually different than payment card networks, and will often use electronic funds transfer from a demand deposit account. Nevertheless, some electronic bill presentment and/or payment systems receive and send data over a network such as is shown in FIG. 2, using capability such as MasterCard Global File Transfer (GFT). Furthermore, US Patent Publication 2010-0100480 of Theresa Altman et al., hereby expressly incorporated by reference herein in its entirety for all purposes, describes a system wherein payment of a bill using a payment card account is facilitated by formatting and dispatching a message from a bill payment provider to an electronic bill payment system. The message is flagged with a flag indicating that the message includes a non-financial, card payment, message. The message includes an identification of the biller, a card number of the payment card account, and an expiration date of the payment card account. The message is an electronic funds transfer message augmented with the flag, the card number, and the expiration date.

Some electronic bill payment systems use technology such as described in the herein-referenced US Patent Publication 2013-0290177 A1 of Milam and Klaus to reduce the number of non-electronic payments. Some electronic bill payment systems use technology such as described in the herein-referenced US Patent Publication 2013-0311362 A1 of Amy C. Milam et al. to facilitate approximately matching entered payee information to stored biller information.

### Automated Sequential Electronic Payments

Note that currently, in some circumstances (such as the advertising scenario shown in FIG. 5), use of paper checks is still quite prevalent. Indeed, currently, the majority of payments between buyer and seller which pass through an intermediary are settled via paper check and have a significant time lag and a long settlement period. Time lags in payments are realized because both buyers and intermediaries want to preserve working capital, generally at the expense of suppliers who bear additional cost in financing the receivables, combined with requirements for getting paid before making payment (that is to say, intermediary must confirm receipt of funds prior to disbursing funds to the supplier). Sometimes, individual virtual commercial card payments are made between buyers and sellers in an ad hoc manner. Advantageously, one or more embodiments provide a system, method, and/or computer program product that manages the sequencing and timing of payments between buyers and sellers where an intermediary is involved. Indeed, one or more embodiments provide automated sequential electronic payments between a buyer, a seller, and an intermediary. One or more embodiments provide for streamlined payments in industries where intermediaries are typically used between buyers and sellers; one non-limiting example of such a situation is in the procurement of media (e.g., for advertising purposes).

One or more embodiments automate sequential payments when an intermediary is leveraged to manage the relationship between a buyer and a seller. One or more embodiments combine and automate pull and push payments to help neutralize the bottleneck which is commonly created when an intermediary is used.

One or more embodiments accomplish one or more of the following:
a) Speeding up settlement by incenting buyers to pay suppliers earlier due to float and rebate benefits such as may be obtained from a commercial card program.
b) Automating the second payment between the intermediary and the supplier immediately after the first payment from the buyer is received by the intermediary, thereby eliminating a payment bottleneck and satisfying any sequential liability requirements.

FIG. 5, discussed in greater detail below, is a process flow diagram showing a payment process in accordance with the prior art. In particular, FIG. 5 shows a current Media Purchase Process Flow with Net 30 Terms. End-Corporates 502 are slow to pay Ad Agencies 504 due to motivations to preserve working capital and keep high Days Payable Outstanding metrics (e.g. 45 days+). Delays on collections are causing Ad Agencies 504 to subsequently delay payment to Media Suppliers 506, forming a payment “bottleneck” at this step. Media Suppliers 506 realize compound payment delays—first from the End-Corporate 502 and second from the Agency 504—resulting in Days Sales Outstanding (DSO) metrics that are often twice the payment terms. Thus, the use of Ad Agencies 504 by Corporates 502 creates a payment “bottleneck,” causing frequent late payment and high Supplier DSO.

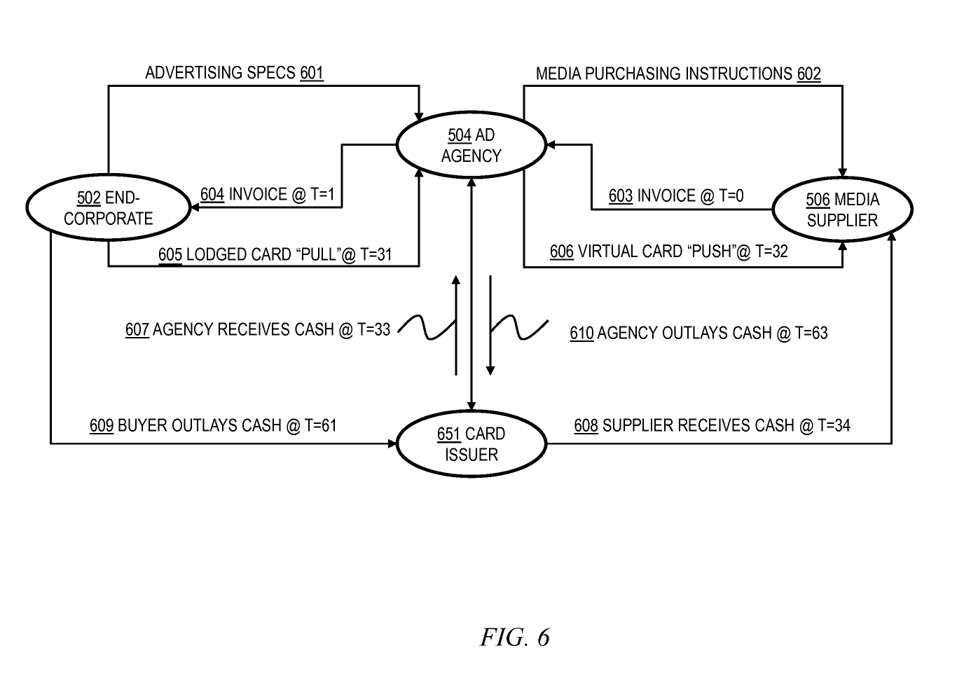

FIG. 6, also discussed in greater detail below, is a process flow diagram showing a payment process in accordance with an aspect of the invention. In particular, utilizing both “Pull” and “Push” payment solutions simultaneously can neutralize the Agency bottleneck issue. At a high level, prior to the transaction, a credit card account is issued to End-Corporate 502 for use specifically with Ad Agency 504 (which is generally representative of an intermediary). In a non-limiting example, End-Corporate 502 is issued a so-called “Lodged Card” solution or “Ghost Card” account, and Ad Agency 504 is issued a Virtual Card solution (again, in a non-limiting example, by a single card issuer 651 in both cases). Note, however, that in an alternative embodiment, there can be two separate card issuers—one for intermediary 504 and one for end-corporate 502. Also note that in the non-limiting example, both (i) the “Lodged Card” solution or “Ghost Card” account AND (ii) the Virtual Card solution are technically virtual card solutions in that no plastic is issued, just accounts.

Following service delivery, Media Supplier 506 invoices Ad Agency 504 according to the normal invoicing schedule (e.g. Net 30 terms); Ad Agency 504 subsequently invoices the End-Corporate 502 for the amount due. Upon invoice maturity, Ad Agency 504 “pulls” payment from the End-Corporate Lodged Card (T=31) (“T=” notations herein are non-limiting exemplary times in days). Upon receiving authorization for settlement of the End-Corporate invoice, Ad Agency 504 then “pushes” Virtual Card number to Supplier (T=32); this step can be automated to further streamline the process. End-Corporate 502 and Ad Agency 504 both settle transactions with Issuer 651 upon conclusion of the billing period (e.g. T=61-63). In the example shown, invoicing is assumed to take place after advertising services have been rendered, and disputes are assumed to be addressed in the 30 day invoicing period between the End-Corporate 502, Agency 504, and Supplier 506.

The “Pull-and-Push” payment process advantageously addresses several shortcomings in the current payment process used by End-Corporates, Agencies, and Suppliers. The “Pull-and-Push” solution speeds payment to Media Suppliers by one, some, or all of the following:
Creates incentives for a speedier first step in the payment process by encouraging on-time payment by End-Corporates due to float and rebate benefits from card payment;
Increases payment timing control on the part of the Ad Agency, who is now able to initiate payment processing on the invoice due date;
Decreases the time lag between Agency processing of End-Corporate payment and executing payment to Supplier—especially if this step is automated;
Creates incentives for card acceptance by Media Supplier due to quicker cash realization.

Issuers and Acquirers can facilitate a “Pull-and-Push” payment process by, for example, one, some, or all of the following:
Issuing Lodged Card to End-Corporate
Issuing Virtual Card to Ad Agency
Enabling Ad Agency for “pull” acceptance of Lodged Card
Enabling Media Supplier for “push” acceptance of Virtual Card
Noting that customized economics may be offered to satisfy ecosystem cost sensitivities.

Push-pull can also be facilitated by providing system (e.g., system 802 discussed below) that automatically generates a push payment upon receipt of the authorization code from a pull payment.

FIG. 5, as noted, shows a prior art approach. An example is shown in the context of the media industry; however, similar payment flows exist in many other applications. A corporate customer 502 (also referred to as “end-corporate” or “corporate client”) uses an intermediary such as advertising agency 504 to pay media supplier 506 on behalf of corporate customer 502. A bottleneck typically exists at the intermediary 504. Typically, this leads to significantly longer payment terms than what is seen in industries without an intermediary. In step 510, corporate customer 502 directs agency 504 to purchase specific media. In step 520, the ad agency 504 advises the media supplier 506 what it is desired to purchase. Once media supplier 506 delivers on the order (e.g., advertisements are placed in print, on-line, on TV or radio), in step 530, the media supplier 506 sends an invoice to the ad agency 504. Then, in step 540, the ad agency sends an invoice to the corporate client 502. Corporate customer 502 examines the invoice and reconciles it and eventually pays the ad agency in step 550. In step 560, ad agency 504 in turn eventually pays the media supplier 506. The notations “T=” refer to the corresponding number of days (values are exemplary and non-limiting). Thus, step 530 is at day zero; step 540 is at day one; step 550 is on a day ranging from day 45 to day 60; and step 560 takes place on day 60 or greater. The supplier 506 typically ends up getting paid well after the normal 45-60 day term; in many instances, well over 100 days, inasmuch as agency 504 typically waits for receipt of buyer payment before paying supplier 506, thus resulting in a payment “bottleneck.”

FIG. 6 shows an exemplary embodiment according to an aspect of the invention. The exemplary embodiment is shown in the context of the media industry; however, similar payment flows exist in many other applications, and other embodiments of the invention can be applied in other situations. A payment card issuer 651 (in a non-limiting example, the issuer of MASTERCARD branded payment cards) inserts itself into the transaction flow to reduce the amount of time that the media supplier 506 waits to be paid. As in step 510, in step 601, corporate customer 502 directs agency 504 to purchase specific media. As in step 520, in step 602, the ad agency 504 advises the media supplier 506 what it is desired to purchase. Once media supplier 506 delivers on the order, in step 603, as in step 530, the media supplier 506 sends an invoice to the ad agency 504. Then, in step 604, as in step 540, the ad agency sends an invoice to the corporate client 502. As before, corporate customer 502 examines the invoice and reconciles it. However, rather than preparing a paper check, if examination and reconciliation indicate that all is in order, corporate customer 502 advises ad agency 504 that it is ready to pay the invoice. Ad agency 504 (and/or a third party as discussed below) has a payment card number on file. In step 605, corporate customer 502, having determined from examination and reconciliation that all is in order, advises ad agency 504 that ad agency 504 (and/or a third party as discussed below) is authorized to make a charge against the on-file payment card number. This is referred to as a “pull payment”; the ad agency 504 (and/or a third party as discussed below) “pulls” the payment from the corporate client 502. Furthermore, in one or more embodiments, this “pull” payment triggers a series of additional events. Note that in the non-limiting example of FIG. 6, step 605 occurs on day 31 (it is assumed that any disputes have been addressed in the 30 day invoicing period between the End-Corporate 502, Agency 504, and Supplier 506). Note also that the terminology “lodged” card pull payment means that the card details have previously been lodged (placed on file) at the ad agency 504 (and/or at a third party as discussed below) and resides within the computer system(s) of the ad agency 504 (and/or those of a third party as discussed below).

As noted, in one or more embodiments, this “pull” payment triggers a series of additional events. For example, once the “pull” occurs, a payment is directed to the media supplier 506—such payment can be in the form of a virtual card “push” as seen in step 606 on day 32. That is to say, ad agency 504 (and/or a third party as discussed below), with payment in hand from corporate client 502, uses technology in accordance with one or more embodiments of the invention to automate the creation and distribution of a virtual payment card number to the media supplier 506. Advantageously, this significantly reduces the amount of time between the media supplier 506 presenting its invoice to the ad agency 504 and the media supplier 506 ultimately being paid.

In a “pull” payment, the entity to be paid initiates the payment; in a “push” payment, the entity doing the paying initiates the payment. Stated in another way, in a “pull” payment, the card account is processed by the merchant using existing point-of-sale or point-of-interaction technology with the merchant's acquirer; in a “push” payment, the buyer rather than the supplier or merchant pushes the information to the merchant's acquirer (e.g., via a gateway such as the electronic transaction apparatus described in U.S. Pat. No. 8,732,044 of Lovelett, et al., expressly incorporated herein by reference in its entirety for all purposes). Suitable alternate terminology is “supplier initiated payment” (same as PULL—entity to be paid (or third party as discussed) has card number and will “hit” number) and “buyer initiated payment” (PUSH—buyer only gives the entity to be paid (or third party as discussed) the card number and directs that entity to “hit” the card when buyer is ready to). Note that “buyer” and “supplier” in this context refer to parties locally within the transaction. For example, in step 605 the ad agency is functioning as the supplier to the corporate client (“buyer”) 602. A payment card (e.g., purchasing card) of the corporation 502 is lodged at agency 504 (or third party as discussed) and, only upon approval of the corporate client 502, the ad agency 504 (or third party as discussed) is allowed to initiate a transaction using the previously-lodged purchasing card. This in turn causes the virtual card push payment to the media supplier 506 in step 606.

As an aside, it is worth noting at this point that in some instances, an auto-approve feature is provided whereby the ad agency pulls funds via an on-file account based on specific conditions agreed to with end corporate; for example where media placement occurs as ordered by end-corporate and an invoice can be provided post-payment for auditing purposes.

In at least some instances, there are steps and/or conditions that should be satisfied prior to or between “hitting” the lodged card in step 605 and initiating the virtual card payment in step 606. For example, in some embodiments, the ad agency 504 must provide proof to the corporate client 502 that the media purchases that were intended to be made were in fact made with the media supplier 506. Once this aspect is reconciled, then the ad agency 504 (or third party as discussed) can “hit” the lodged card for the payment. That is to say, in at least some cases, some type of proof of delivery of the services is required. Furthermore in this regard, in some cases, the invoice will be reviewed between T=1 and T=31. Corporate client 502 looks at the invoice and ensures that it is ready for payment; i.e., that all obligations have been met.

Again, for the avoidance of doubt, while non-limiting examples are given herein in the context of media reconciliation, many other situations involve intermediaries and can potentially benefit from use of one or more embodiments of the invention to reduce “bottleneck” issues. For example, consider a law firm that represents a corporation and hires local counsel for filing in foreign countries (“foreign associates”). The law firm fulfills the role of the agency 504 and the foreign associates take on the role of the media supplier 506.

Consider now step 607, “agency receives cash @ T=33.” When ad agency 504, acting as a merchant with respect to end-corporate 502, charges the lodged card at T=31 in step 605, 2-3 days later the agency 504 will receive payment through the ad agency's merchant bank (“acquirer,” “acquiring bank,” and “merchant bank” are used synonymously herein), from the issuer 651, via a payment card network (e.g., BANKNET or similar network 2008). This is reflected by the notation T=33 associated with step 607 (assumes 2 days elapsed from T=31). The third party could charge the lodged card on behalf of the agency. As an aside, please note the double-headed arrow linking card issuer 651 and ad agency 504; the upward direction represents step 607 and the downward direction represents step 610, discussed below. Now continuing, in step 608, at T=34 (for example), when the media supplier 506 accepts the card that they are sent by the ad agency 504, they (the media supplier) will also be paid in 2-3 days (T=34 assumes 2 days elapsed from T=32). The third party could send the card on behalf of the agency. In one or more embodiments, media supplier 506 receives a virtual card number in step 606; media supplier 506 uses that card number to send a conventional authorization request into BANKNET; that request is processed normally (authorization request response and subsequent clearing and settlement in batch mode, e.g.). Steps 607 and 608 satisfy the accounts receivable for both the agency 504 and the supplier 506—both suppliers (i.e., agency 504 and media supplier 506) have been paid at this point; the bank (issuer 651) has not yet been paid. Generally, there is a thirty day cycle or term on credit cards. In step 609, at T=61, 30 days after the agency 504 or third party acting on its behalf “hits” the lodged card of corporate client 502, the corporate client 502 pays the bank (issuer 651). Similarly, at T=63, step 610, the ad agency 504 pays the bank (issuer 651) for the charge that was sent to the media supplier 506.

Non-limiting examples will now be provided of one or more particular machines suitable for practicing the steps of one or more embodiments, as well as comments on how the functioning of such machine(s) can be improved using one or more aspects of the invention.

Steps 601 and 602: These steps can be implemented using a variety of techniques, such as a phone call, informal sketch or verbal instructions delivered in person, e-mail, conventional postal mail, or the like. In some instances, sophisticated third party software systems such as those available from Mediaocean, New York, N.Y., USA; Advantage Software, Inc., Mooresville, N.C., USA; and/or Strata Marketing, Inc., Chicago, Ill., USA; can be used.

In some embodiments, data is transferred from third party systems to a system 802 in accordance with one or more embodiments, in order to carry out reconciliation. For example, the third party might provide data indicating that an ad placement met the conditions of the ad buy (in terms of rating, e.g.). The rating data is then applied against the conditions in the system to allow the process to move forward to the next step (pull and push process). Thus, in one or more embodiments, a new interface is provided from a third party system to indicate that payment is appropriate because the required media has been purchased and has met its rating requirements (e.g., sufficient impressions). Marketron Inc. of Hailey, Idaho, USA provides pertinent data that can be used in one or more embodiments. In at least some instances, Marketron data acts like an invoice to verify that something has occurred.

Steps 603 and 604: These steps can be implemented using a variety of techniques, such as e-mail; conventional postal mail; via an electronic bill presentment system (e.g., the presentment part of a BPPS as described with regard to FIG. 3); at least some of the sophisticated third party software systems mentioned above; an enterprise resource planning (ERP) system; or the like. ERPs are known in and of themselves to the skilled artisan and are further discussed in U.S. Pat. No. 8,732,044 of Lovelett, et al., expressly incorporated herein by reference in its entirety for all purposes. Given the teachings herein, the skilled artisan will be able to implement one or more embodiments of the invention in the context of an ERP.

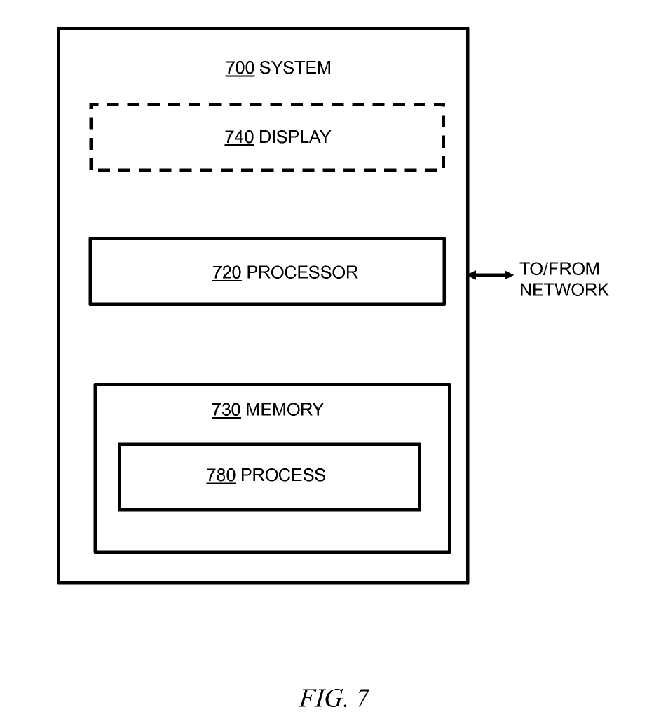

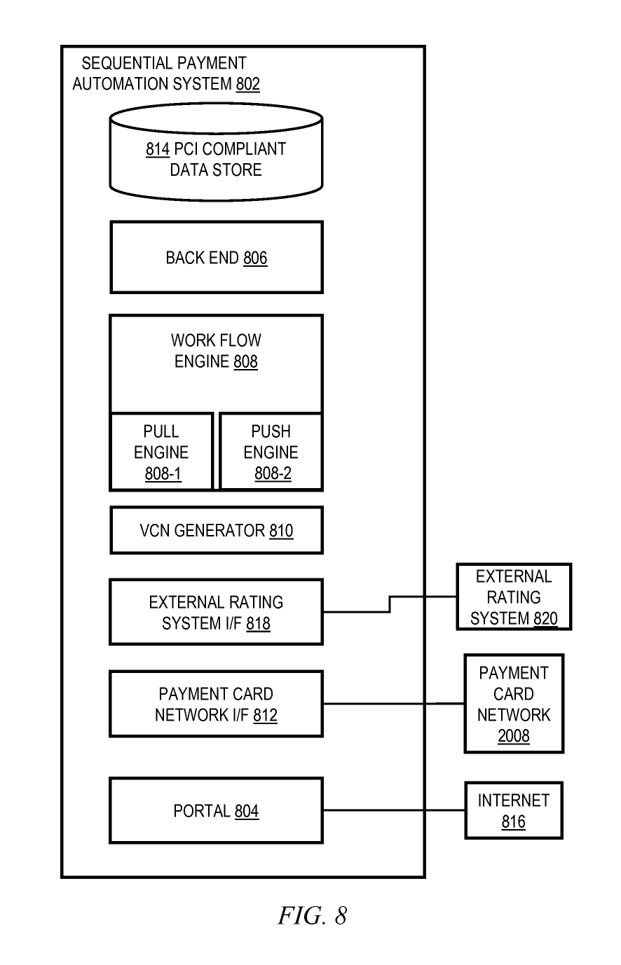

Step 605: In some cases, intermediary (here, ad agency 504) is allowed to store the payment card account number issued to it by end-corporate 502 in a manner that complies with the standards promulgated by the PCI Security Standards Council, LLC, Wakefield, Mass. USA. In one non-limiting example, there is a PCI-compliant data store on a server 700 (see FIG. 7) at the ad agency 504 or other intermediary. The ad agency 504 or other intermediary may be authorized to carry out the “pull” using a variety of techniques. For example, they may be authorized to undertake the pull upon satisfactory execution of the media purchase/placement, or upon completion of reconciliation. In the media industry, an ad may be placed with a television network; the ad then runs in the appointed spot. Ads may also be placed on radio, the Internet, etc. An impression (e.g., in the context of online advertising) is a measure of the number of times an ad is seen. Impressions are a common measurement method in advertising. Often, gross rating points (GRPs) or target rating points (TRPs) are used to measure the size of an audience reached by a specific media or schedule. Specifically, GRPs quantify impressions as a percentage of the population reached rather than in absolute numbers reached. Target rating points express the same concept, but with regard to a more narrowly defined target audience. Impressions may be determined or verified by organizations such as The Nielsen Company, New York, N.Y., USA. Once an ad has run and (if required) achieved the desired performance in terms of impressions or the like, as required by the specifications “specs” in step 601, the invoice is issued in step 604 and the agency or third party acting on its behalf is allowed to “hit” the lodged card in step 605. In some cases, an electronic communication is employed. For example, one or more embodiments provide an on-line portal 804 (see FIG. 8), discussed below (via secure Internet), where the buyer (end corporate) can view all the invoices that they have received from the agency 504. Corporate client 502 uses the portal to view a particular invoice and determine that it has been reconciled; corporate client 502 then approves the invoice in question for payment via the portal. In one or more embodiments, there is a back end 806 responsive to the portal, which involves a communication from end corporate 502 to ad agency 504 to direct the agency to initiate the pull payment of step 605. Thus, in some embodiments, step 605 goes forward upon approval from the buyer (end-corporate 502) while in other instances, agency 504 is permitted to auto-approve step 605. With regard to this latter, auto-approve option, the supplier (here, agency 504 in relation to end-corporate 502), if certain conditions are met under the terms of the purchase agreement, is authorized to pull the payment (carry out step 605)—the ad agency in effect self-certifies. This is somewhat analogous to rules in place today wherein a merchant is allowed to “hit” a card once the merchant ships goods. It is worth noting that the timing can be adjusted depending on which option is used. For example, T=31 for lodged card pull step 605 reflects a 30 day reconciliation period of the buyer allowing supplier to hit lodged card. In a self-certification scenario, the time could be further shortened almost to the point of when the invoice is submitted. In any event, note that all times are non-limiting examples.

Step 606: Consider the virtual card push of step 606. In some cases, the virtual card number is created by MasterCard's IN CONTROL or a similar product (generally, a virtual card number generation facility 810), using techniques such as those described in the herein-mentioned two Flitcroft patents. Ad agency 504 or a third party acting on its behalf contacts the virtual card number generation facility, requests a virtual card number, obtains the virtual card number in response, and pushes the virtual card number to the supplier. In a non-limiting example, this can be done via e-mail. In an alternative approach, media supplier 506 connects as a party to the above-discussed secure portal and retrieves the account information. In such cases, there may still be an e-mail to the supplier to advise the supplier that a virtual card number is waiting for them and they should go to the portal and retrieve it. Consider aspects of automation occurring from the time when the lodged card is “hit” to the time when the virtual card number is created. When the first card (lodged card) is “hit” by the ad agency, the ad agency will obtain an authorization (“auth”) number for that transaction. The return of that auth number triggers the workflow to generate the virtual card and the notification to the media supplier that a virtual card number payment is waiting for them. In some cases, the receipt of the “auth” number may not result in immediate virtual card creation. There may be additional intermediate steps such as approval, or the ad agency may need to make sure that the invoice that the media supplier gave them was reconciled, and so on. The creation of the “auth” nevertheless triggers that intermediate workflow, which is determined by the ad agency as appropriate. For example, the ad agency may want three steps; or they may pay as soon as their funds come in. One or more embodiments include reconciliation by the ad agency to make sure that it is meeting its sequential liability requirements.

In some cases, a work flow engine 808 resides on a server at agency 504 and the work flow is triggered by obtaining the “auth” number. Alternatively, the work flow engine can reside on a server of the card issuer 651 or in an alternative location. For example, the virtual card number generation facility may reside on a server of the operator of a payment card network and the workflow engine can also reside there. When the server does not reside at the ad agency 504, there may be a data interchange between the server and the ad agency. The work flow engine and interfaces may reside with a third party system; for example, in a cloud or software as a service environment. Thus, one or more embodiments are implemented by a party that is a third party to all three parties to the transaction(s) per se (i.e., end-corporate 502, ad agency 504, and media supplier 506). This third party can be, for example, one or more of the following:
issuer 651 (typically a financial institution);
MasterCard (or other payment card network operator);
an acquirer (typically a financial institution) such as the acquirer of the intermediary;
issuer processor(s) and/or acquirer processor(s) such as First Data Corporation, Atlanta, Ga., US; or Total System Services, Inc. (TSYS), Columbus, Ga., US;
a third party service provider (typically not a financial institution).

The payment card network operator could provide a platform such as the MASTERCARD PURCHASE CONTROL® commercial payments solution (registered mark of MasterCard International Incorporated, Purchase, N.Y. US) or a similar platform. Non-limiting examples of third party service providers include ANCHOROPS, INC., Westborough, Mass., USA and CSI/CardPayment Solutions (Registered ISO of Wells Fargo Bank, N.A., Walnut Creek, Calif., US). These third party providers could provide, for example, alternative commercial payments solutions.

Further comments on Step 605: the card number for the lodged card could be stored by agency 504 or the aforementioned third party. Storage by the third party may be particularly suitable when the ad agency is not PCI-compliant. The generation of the virtual card number (VCN) may occur, for example, at a virtual card number generation facility such as an IN CONTROL server at MasterCard or the like. The work flow that is triggered once the auth number is returned for the “pull” may be carried out, for example, using a work flow engine that may, for example, be located at the aforementioned third party and be used by ad agency 504. Thus, in one or more embodiments, ad agency 504 securely accesses an application (“app”) provided by the operator of a payment card network or other third party (e.g., issuer 651).

Thus, to summarize, in one or more embodiments, a work flow engine 808 runs at a third party such as issuer 651 or the operator 2008 of a payment card network. Once the “auth” number is generated, it triggers the work flow engine 808. If all the correct conditions are satisfied, the work flow engine initiates step 606, “push” to media supplier 506. This push can include, for example, an e-mail with the VCN or an e-mail telling supplier 506 to log on securely to a portal where the supplier can obtain the VCN. In one or more embodiments, the portal is part of the third party system. The third party system 802, in one or more embodiments, advantageously includes and integrates a number of discrete applications.

Further Aspects of Step 606 and Settlement Steps 607-610: in some cases, settlement steps 607, 608, 609, and 610 are carried out using standard batch processing functionality in a payment card network such as BANKNET or the like. In some cases, the standard settlement process is modified to include special reference information passing through a payment card network such as BANKNET during the settlement process; for example, an invoice number or some other indication. Note that in some cases, the ad agency reconciliation as to the media supplier is based on the single use virtual account number employed in step 606. Employing a single use account is beneficial because it creates a one-to-one relationship and eases reconciliation on the back end. However, other approaches could be used in other embodiments. For example, some embodiments use straight-through processing via a dynamic account with the same number used repeatedly. In this context, a “dynamic account” means that the same account is used repeatedly, but that the issuer processor puts a control on the account that only opens the line of credit for a certain amount and for a certain period of time. In essence, this approach involves the use of velocity controls instead of issuing a new account number for each transaction. In a further alternative embodiment for step 606, instead of providing media supplier 506 with a virtual card number, the third party service has a card number of the media supplier 506 on file and uses a special transaction to put funds onto the card; this is somewhat analogous to an approach using a pre-paid card where the amount of the transaction is controlled. Thus:
in one aspect, in step 606, the system creates a true single use virtual card account
in a first alternative aspect the system engages controls to utilize an existing multiple-use card account for limited circumstances (e.g., establishing the credit limit associated with a specific transaction or pre-funding the card account for the amount of the transaction). That is, instead of generating a new account number each time, there is only one account number associated with funds going from the ad agency to the media supplier; however, appropriate controls are used to “turn it on” for a certain amount—e.g., e-mail the supplier 506 and advise them that they are authorized to put an auth request into the system for that account number, but only for, say $5000. This kind of functionality exists today, in and of itself, in MasterCard's inControl™ technology, but is being used here in a novel and unobvious manner. Given the teachings herein, the skilled artisan will be able to use technologies such as MasterCard's inControl™ technology to implement one or more embodiments.
in a second alternative aspect the system uses a special transaction to put funds on to the card of the supplier 506 (e.g., ISO-8583 message type 0100 with transaction type twenty eight, or an ISO-8583 message type 0200 with transaction type twenty eight), such as the MasterCard MONEYSEND Payment Transaction. Several different non-limiting exemplary scenarios regarding special transactions such as the MasterCard payment transaction or MoneySend will now be presented. In one scenario, a dual message model is employed. An “auth request” is sent (ISO-8583 message 0100 with Transaction Type (DE3sf1)=“28” (Payment Transaction)) from the buyer's (entity that acts as the buyer within this particular transaction—agency acts as buyer as to the supplier) bank to the supplier's bank, over a payment card network (network 2008 is a non-limiting example). This guarantees the money transfer (reserves funds for the seller). Subsequently (for example, in one day) a “First Presentment” message 1240 is sent in a bulk file which completes the transfer. In another scenario, a single message model is utilized. A Financial Transaction request is sent (ISO-8583 message 0200 with Transaction Type (DE3sf1)=“28” (Payment Transaction)) from the buyer's bank to the supplier's bank, over a payment card network (network 2008 is a non-limiting example). It is worth noting at this point that ISO 8583 message type 0100 is used in a conventional transaction as an authorization request from the acquirer 2006 to the issuer 2010 of the consumer's card, to which the issuer 2010 responds with an authorization request response 0110. The message type 0100 is also utilized conventionally for chargebacks and the like. The message type 0100 is utilized in a different way here based on a different code/transaction type than in the conventional applications (Transaction Type (DE3sf1)=“28” (Payment Transaction)).

Note that US Patent Application Publication 2010-0100480 A1 of Theresa Altman et al., expressly incorporated herein by reference in its entirety for all purposes, discloses an innovative technique for allowing users of an electronic payment bill payment system to pay billers using payment card accounts of the payors not the billers, by sending a non-financial message through the electronic payment bill payment system, including the card number of the payor's card; the biller then charges the payor's card in a conventional manner. In some circumstances, such techniques could be used to provide the agency or third party with the lodged card details of the corporate client 502 or to send the virtual card details to the supplier 506.

Also, note that wherever card numbers are supplied, other needed details such as expiration date and security code can also be supplied as appropriate. Furthermore, note that in one or more embodiments, at least some aspects of steps 605, 606, 607, 608, 609, and 610 can be carried out or otherwise facilitated with a payment card network.

FIG. 8 is an exemplary software architecture diagram of a sequential payment automation system 802, in accordance with an aspect of the invention. PCI compliant data store 814 securely stores payment card account numbers, and optionally, related expiration date and security code information. Virtual card number (VCN) generation facility 810 uses MasterCard's IN CONTROL or a similar product to generate virtual card numbers, using techniques such as those described in the herein-mentioned Flitcroft patents. In some cases, payment card network interface 812 can be implemented as a PNIP as described above (e.g., a MasterCard Interface Processor (MIP) or the like). A MIP is a front-end communications processor that is, for example, placed on-site at a MasterCard customer's facility by MasterCard for the purpose of providing access to the BANKNET telecommunication network (e.g., 2008). When interface 997 is implemented as a MIP, for example, it may be on a separate hardware processor from the rest of system 802 and may communicate therewith via a suitable network.

A PNIP such as a MIP is typically located on the premises of the acquirer or issuer as seen in FIG. 9. Where system 802 is not in such a location, interface 812 might include elements such as interface 2016 and/or terminal driver 2014 to facilitate interconnection with a PNIP. Furthermore, if system 802 was located at the premises of a payment card network operator, for example, a machine similar to a PNIP could be employed as interface 812 in some circumstances, in a manner analogous to that described with regard to element 2068.

Optional back end 806 may, in some instances, be responsive to the portal, and may obtain, for example, a communication wherein end corporate 502 directs ad agency 504 to initiate the pull payment of step 605. Portal 804 may securely serve out HTML code over Internet 816 to client computers at any of the parties to enable the communications described herein. Work flow engine 808 may include, for example, compiled or interpreted high-level code that implements the logic described elsewhere herein. Optionally, engine 808 is broken into pull engine 808-1 which implements the pull payment and push engine 808-2 which implements the push payment. Once the auth code for the pull payment is received, the push payment workflow may commence, automatically generating the push payment. External rating system interface 818 interfaces with external rating system 820. In the non-limiting example of media advertising purchases, system 820 is provided by, for example, Marketron, Inc.; Mediaocean; Advantage Software, Inc.; and/or Strata Marketing, Inc. Interface 818 can be, for example, suitable code that accesses an API exposed by the system 820. In other applications, other systems that verify compliance with an objective can be utilized.

In another aspect, instead of using a VCN, suitable gateway functionality is employed (the gateway such as the electronic transaction apparatus described in U.S. Pat. No. 8,732,044 of Lovelett, et al. is a non-limiting example of a suitable gateway). In this aspect, system 802 stores card account information for both pull and push payments and settles both streams of transactions by pushing transactions out of the system directly to the acquirers without manual intervention. In one or more embodiments, this provides a faster and more secure way to deliver account information directly to the banks of the payment recipients. One or more embodiments employ integration with acquirers, storing card account numbers for pull and push payments and sending account numbers directly to the acquirers without manual intervention. A suitable gateway facilitates direct integration with one or more acquirers.

In one or more embodiments, system 802 improves the functioning of purchasing system between end-corporate and the supplier.

It should be noted that in one or more embodiments, system 802 creates a unique identifier to link the transactions together (e.g., a trace number to link pull payment to push payment). In a non-limiting example, this is done by work flow engine 808 using logic apart from the pull and push engines.

Given the discussion thus far, it will be appreciated that, in general terms, one aspect of the invention includes a method for automating sequential electronic payments, in a scenario where a buyer 502 purchases at least one of goods and services from a seller 506 via an intermediary 504. One step includes obtaining, at the intermediary and/or a third party, an indication that payment to the intermediary from the buyer is appropriate.

In some instances, this step of obtaining an indication is carried out by buyer 502 indicating approval via portal 804 over a secure connection using Internet 816, with back end 806 advising the intermediary 504. The buyer can receive a notification from the system 802 indicating that an invoice is ready for approval; for example, upon reconciliation of the media purchase that is required as a condition before the payment is pulled. Once that happens, a system notification goes out to the buyer (end corporate) and the end corporate will then come in and trigger the payment for the payment to actually be released.

In some instances, this step of obtaining an indication is carried out via an auto-approval process. Once conditions are satisfied/reconciled around the purchase agreement for the media buy, the system 802 (in particular, the workflow engine 808) takes the card account on file and essentially sends a message directly to the acquirer to process the transaction and pull it through the system, hitting the card account and paying the merchant or the ad agency in, say, two days. Auto approval is preferred in at least some cases because it is faster. With regard to the workflow engine 808, the same may have additional functionality as described herein besides that in the (optional) pull and push engines. In one or more embodiments, the aspect of the system taking the card account on file and sending a message directly to the acquirer is carried out before the “pull.” In essence, the engine 808 undertakes a three-way match for the purchase request 601, invoice 603, and whatever indication (e.g., third party rating data from system 820) is relied on to confirm that the media purchase met expectations.

In some instances, this step of obtaining an indication involves the elapse of an appropriate amount of time from the invoice date without dispute (calculated, for example, by a timer or calendar function within system 802).

In some instances, this step of obtaining an indication involves the intermediary 504 self-certifying via portal 804.

It is worth noting as an aside that in one or more embodiments, the Buyer, Intermediary, and Media supplier all access system 802 via the same portal 804, with access controls specific to each user. Of course, two or more different portals could be used in other embodiments.

Now continuing with the description of the exemplary method, in a further step, responsive to the indication being obtained, the intermediary and/or the third party initiates a pull payment, via a payment card network (2008 is a non-limiting example), for an on-file payment card account number of the buyer. This step can be carried out, for example, by Work Flow Engine 808 in system 802 pulling the account number from data store 814 and sending it into network 2008 via payment card network interface 812. Where engine 808 is divided into pull engine 808-1 and push engine 808-2, this step can be performed with pull engine 808-1.

In a still further step, responsive to success of the pull payment, the intermediary and/or the third party initiates a push payment to the seller. One example of “success” is getting the “auth” number for the pull payment back from the acquirer via the payment card network and into the work flow engine 808. The auth number is provided from the acquirer back to system 802 over network 2008 or the like over interface 812. In at least some instances, the timing for generation and release (push) of the virtual card number can be configured and/or scheduled by the Agency to allow for review and reporting. Single or multi-use virtual card numbers can be employed. Controls on the virtual card can be set, for example, by the issuer or issuer processor. Again, optionally, engine 808 includes two work flows; 808-1 around the pull payment and 808-2 around the push payment. Receipt of the “auth” code links the two work flows; it closes out the pull payment and starts the push payment. exemplary push payment details are described elsewhere herein.

Again, as discussed above, references to a “Lodged Card solution” or “Virtual Card solution” are exemplary and non-limiting; in one or more embodiments, it is simply a credit card account issued to end-corporate for use specifically with Ad Agency (which has previously been referred to as Intermediary). Both are technically virtual card solutions in that no plastic is issued, just accounts. Also, as discussed above, the scenario could include one or two different card issuers—one for intermediary and one for end-corporate or same for both.

In some cases, the step of initiating the push payment includes the intermediary and/or the third party making a single-use virtual payment card number available to the seller. This number could be generated by VCN generator 810 and could be provided, for example, as discussed below.

In some instances, the intermediary and/or the third party makes the single-use virtual payment card number available to the seller by sending the single-use virtual payment card number to the seller by e-mail. For example, Engine 808 (optionally push engine 808-2) in system 802 sends e-mail over Internet 816.

In some instances, the intermediary and/or the third party makes the single-use virtual payment card number available to the seller by advising the seller to log onto a secure web portal. For example, Engine 808 (optionally push engine 808-2) in system 802 advises the seller to access Portal 804.

In some cases, the step of initiating the push payment includes the intermediary and/or the third party enabling the seller to make a limited charge against a reusable payment card account number. This step could be carried out, for example, with engine 808 (optionally push engine 808-2).

In some cases, the step of initiating the push payment includes the intermediary and/or the third party initiating a special payment transaction over the payment card network (e.g., 2008) wherein the seller has a payment card account in which the seller can receive payments via the special payment transaction over the payment card network. For example, Engine 808 (optionally push engine 808-2) sends into network 2008 via interface 812 an ISO-8583 message 0100 with Transaction Type (DE3sf1)=“28” (Payment Transaction) or an ISO-8583 message 0200 with Transaction Type (DE3sf1)=“28” (Payment Transaction).

In some cases, additional steps include issuing the on-file payment card account number to the buyer 502; providing a server of the intermediary and/or the third party with access to a virtual card number generator 810; provisioning the server of the intermediary 504 and/or the third party with software to enable the pull payment; and providing a server of the seller 506 with software to enable the push payment. Some embodiments may employ a cloud solution where little or no provisioning is required.

There are many different ways that an indication can be obtained that payment is appropriate; non-limiting examples include: (1) buyer goes on portal and approves, (2) auto-approval, (3) time lapse, and (4) self-certification by intermediary. One example of auto-approval is the case where the parties agree that for certain kinds of media, further certification is not needed. Furthermore in this regard, while online media has many potential discrepancies, in radio, it is much easier to confirm that an ad was aired. In some cases, payment might be made for radio spots five days after invoice receipt. In some cases, self-certification could involve linkage to an entity such as Mediaocean or another third party that verifies the number of impressions. Thus, auto-approval might in some instances be employed for non-critical types of media; where verification of the number of impressions is not believed to be required. In such cases, the mere fact the ad has been placed and aired is sufficient. In auto-approval, the: buyer sets up conditions with the system in accordance with their relationship with the agency; for example, for a simple spot purchase or below a certain monetary threshold, such that no audit is needed. This can also be implemented on a “by supplier” basis. In auto-approval, the trigger is the presentment of the invoice. In some cases, flagging is employed to flag for eligibility for auto-approval based on party eligibility. In another aspect, logic is provided to recognize a media buy as, for example, a radio buy or other buy that is eligible for reduced scrutiny.

In some cases, the obtaining, at the intermediary and/or the third party, of the indication that the payment to the intermediary from the buyer is appropriate, includes the buyer authorizing the payment to the intermediary from the buyer. For example, the buyer assents via a secure web portal 804 of the intermediary and/or the third party.

In some cases, the obtaining, at the intermediary and/or the third party, of the indication that the payment to the intermediary from the buyer is appropriate, includes at least obtaining an indication that an outside agency certifies that the at least one of goods and services meet a required standard. For example a rating agency certifies ad impressions.

As noted, in some cases, all parties use the same portal, and the parties may be provided with different access controls to the portal.

In some cases, the obtaining, at the intermediary and/or the third party, of the indication that the payment to the intermediary from the buyer is appropriate, includes elapse of a period of time previously agreed to by the intermediary and the buyer. This might be implemented, for example, via timer or calendar functionality on system 802.

In some cases, the obtaining, at the intermediary and/or the third party, of the indication that the payment to the intermediary from the buyer is appropriate, includes at least presentment of an associated invoice (or other suitable documentation) to end-corporate 502 in accordance with a prior agreement (i.e., prior agreement permits intermediary and/or third party to treat presentment of an associated invoice (or other suitable documentation) to end-corporate 502 as a “trigger.”

In some instances, notifications are frequently sent to parties, reminding them that they need to log in and approve the payment.

As noted elsewhere, on or more embodiments include provision of a system; the system includes distinct software modules, and each of the distinct software modules is embodied on a non-transitory computer-readable storage medium. In some cases, the distinct software modules include a portal module and a work flow engine module. In some cases, the distinct software modules include a timer-calendar module (e.g., time and date available in WINDOWS and other operating systems) and a work flow engine module. In some cases, the distinct software modules include an external rating system interface module and a work flow engine module.

In some instances, the buyer assents via the portal module executing on at least one hardware processor; the portal module executing on the at least one hardware processor forms at least a portion of the secure web portal. The intermediary and/or the third party initiates the pull payment and the push payment, at least in part, via the work flow engine module executing on the at least one hardware processor. In some embodiments, separate pull and push engines 808-1 and 808-2 are employed.

In some embodiments, the intermediary and/or the third party obtains the indication that payment is appropriate at least via obtaining an indication that an outside agency certifying that the at least one of goods and services meet a required standard. indication can be obtained, for example, by the external rating system interface module executing on at least one hardware processor; and the intermediary and/or the third party initiate the pull payment and the push payment via the work flow engine module executing on the at least one hardware processor. Again, in some embodiments, separate pull and push engines 808-1 and 808-2 are employed.

In some cases, the intermediary and/or the third party obtains the indication that payment is appropriate via elapse of a period of time previously agreed to by the intermediary and the buyer. The obtaining of the indication that the payment is appropriate includes the elapse of the period of time being calculated by the timer-calendar module executing on at least one hardware processor; and the intermediary and/or the third party initiates the pull payment and the push payment via the work flow engine module executing on the at least one hardware processor. Again, in some embodiments, separate pull and push engines 808-1 and 808-2 are employed.

In some cases, the intermediary and/or the third party obtains the indication that payment is appropriate via presentment of an associated invoice (or similar documentation) in accordance with a prior agreement. The obtaining of the indication that the payment is appropriate includes, for example, invoice presentment (or similar documentation) implemented using a variety of techniques, such as e-mail; conventional postal mail; via an electronic bill presentment system (e.g., the presentment part of a BPPS as described with regard to FIG. 3); at least some of the sophisticated third party software systems mentioned above; an enterprise resource planning (ERP) system; or the like. Furthermore, some embodiments employ evaluated receipt settlement, wherein an invoice is not presented but the buyer, based on other information, such as a memo, receipt, or the like, allows the payment to be issued. In some instances, the intermediary and/or the third party initiates the pull payment and the push payment via the work flow engine module executing on the at least one hardware processor. Again, in some embodiments, separate pull and push engines 808-1 and 808-2 are employed.

It should be noted that FIG. 6 is somewhat simplified to avoid clutter, and that system 802 in FIG. 8 will typically implement techniques of FIG. 6 via integration with a payment card network such as shown in FIGS. 8-13 or the like. In some embodiments, system of 802 of FIG. 8 is interposed between ad agency 504 and issuer 651; the immediate connection from system 802 is a connection to one or more acquirers, not directly to card issuers. The first acquirer is the acquirer of the ad agency. The second acquirer is the acquirer of the media supplier. If the first and second acquirers happen to be the same, payment can be pulled in using that acquirer and the second transaction can be implemented via straight-through processing by sending the card account information to the acquirer of record of the media supplier. It is also worth noting that FIG. 6 includes the viewpoint of the card issuer. The issuer associated with end corporate 502 and the issuer associated with ad agency 504 can, but need not, be the same. The same is true on the acceptance side—the acquirer of the ad agency and the acquirer of the media supplier can, but need not, be the same. Typically, every one of the parties is, in essence, covered by a bank. One or more issuer(s) cover the end corporate and the ad agency. One or more acquirer(s) represent the acceptance side of the transaction for the ad agency under the pull transaction and the media supplier under the push transaction. The “pull” is typically the same in the primary and alternative embodiments—system 802 goes out to the acquirer of the ad agency and pulls the funds through a payment card network (e.g., 2008), pulling the funds into the ad agency's account.

As noted, in some instances, the “push” is implemented in the form of a notification to the media supplier to run a transaction through their acquirer. In an alternative approach, payment is pushed to the acquirer of the media supplier instead of pushing notification and having media supplier use their point-of-sale (POS) device to initiate the transaction.

In one or more embodiments, push payments can be carried out using gateway functionality such as the electronic transaction apparatus described in U.S. Pat. No. 8,732,044 of Lovelett, et al.—this is a non-limiting example of a suitable gateway.

In still another aspect, an apparatus for automating sequential electronic payments, in a scenario where a buyer purchases at least one of goods and services from a seller via an intermediary, includes means for carrying out the method steps of any of the methods described herein.

In a further aspect, an article of manufacture includes a computer program product for automating sequential electronic payments, in a scenario where a buyer purchases at least one of goods and services from a seller via an intermediary. The computer program product includes a tangible computer-readable recordable storage medium, storing in a non-transitory manner computer readable program code. The computer readable program code includes computer readable program code configured to cause the processor to carry out any one, some or all of the method steps herein (e.g., the instructions are loaded into the memory to configure the processor).

In an even further aspect, an apparatus for automating sequential electronic payments, in a scenario where a buyer purchases at least one of goods and services from a seller via an intermediary, includes a memory; at least one processor operatively coupled to the memory; and a persistent storage device operatively coupled to the memory and storing in a non-transitory manner instructions which when loaded into the memory cause the at least one processor to be operative to carry out any one, some or all of the method steps herein. In at least some instances, the instructions on the persistent storage device include distinct software modules as described herein.

The modules can include, for example, a work flow engine module. In some cases, the work flow engine module resides on a server of the intermediary and the at least one processor is a processor of the server. However, the work flow engine module could also reside elsewhere; e.g., a card issuer (either a common card issuer that issues cards for both the intermediary 504 and for end-corporate 502 or an issuer for either one in the case when there are separate issuers).

### System and Article of Manufacture Details

Embodiments of the invention can employ hardware and/or hardware and software aspects. Software includes but is not limited to firmware, resident software, microcode, etc.

Software might be employed, for example, in connection with one or more of modules to implement at least a portion of one or more of the elements of system 802; a terminal 122, 124, 125, 126; a reader 132; a host, server, and/or processing center 140, 142, 144 (optionally with data warehouse 154) of a merchant, issuer, acquirer, processor, other third party described herein, entity described in connection with FIG. 6, or operator of a network 2008 (including functionality in FIGS. 9-13); and the like. Firmware might be employed, for example, in connection with payment devices such as cards 102, 112, as well as reader 132.

FIG. 7 is a block diagram of a system 700 that can implement part or all of one or more aspects or processes of the invention. As shown in FIG. 7, memory 730 configures the processor 720 (which could correspond, e.g., to processor portions 106, 116, 130; a processor of a terminal or a reader 132; processors of remote hosts in centers 140, 142, 144; processors of merchant, issuer, acquirer, processor, other third party described herein, entity described in connection with FIG. 6, or operator of a network 2008 (including functionality in FIGS. 9-13); and the like); to implement one or more aspects of the methods, steps, and functions disclosed herein (collectively, shown as process 780 in FIG. 7). Different method steps can be performed by different processors. The memory 730 could be distributed or local and the processor 720 could be distributed or singular. The memory 730 could be implemented as an electrical, magnetic or optical memory, or any combination of these or other types of storage devices (including memory portions as described above with respect to cards 102, 112). It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an application specific integrated circuit (ASIC) or field programmable gate array (FPGA) rather than using firmware. Display 740 is representative of a variety of possible input/output devices (e.g., displays, printers, keyboards, mice, touch screens, touch pads, and so on).

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk. The medium can be distributed on multiple physical devices (or over multiple networks). For example, one device could be a physical memory media associated with a terminal and another device could be a physical memory media associated with a processing center. As used herein, a tangible computer-readable recordable storage medium is defined to encompass a recordable medium (non-transitory storage), examples of which are set forth above, but does not encompass a transmission medium or disembodied signal.

The computer systems and servers described herein each contain a memory that will configure associated processors to implement the methods, steps, and functions disclosed herein. Such methods, steps, and functions can be carried out, by way of example and not limitation, by processing capability on one, some, or all of elements 122, 124, 125, 126, 140, 142, 144, 2004, 2006, 2008, 2010; on a computer implementing system 802; on processors of hosts and/or servers of other parties described herein; on a computer implementing functionality as in FIGS. 9-13; and the like. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the invention, such as, for example, 122, 124, 125, 126, 140, 142, 144, 2004, 2006, 2008, 2010; a computer implementing 802 and its components; on processors of hosts and/or servers of other parties described herein; functionality in FIGS. 9-13; and the like, can make use of computer technology with appropriate instructions to implement method steps described herein. Some aspects can be implemented, for example, using one or more servers which include a memory and at least one processor coupled to the memory. The memory could load appropriate software. The processor can be operative to perform one or more method steps described herein or otherwise facilitate their performance.

Accordingly, it will be appreciated that one or more embodiments of the invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 700 as shown in FIG. 7) running a server program. It will be understood that such a physical server may or may not include a display, keyboard, or other input/output components. A “host” includes a physical data processing system (for example, system 700 as shown in FIG. 7) running an appropriate program.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures. Referring again to FIG. 8, in one or more embodiments, the modules include modules to implement elements 804, 806, 808, 810, 812, 818, and 814 (814 will typically also include persistent storage), and optionally a timer-calendar module (e.g., time and date available in WINDOWS and other operating systems). The modules could also include modules to implement described functionality in FIGS. 9-13. In some cases, payment card network interface 812 can be implemented as a PNIP as discussed above. When interface 997 is implemented as a PNIP, for example, it may be on a separate hardware processor from the rest of system 802 and may communicate therewith via a suitable network. Appropriate software modules may run on the PNIP. other embodiments, software modules and/or a network interface card or the like are provided on the same machine as system 802 to interface with the payment card network. The method steps can, in any event, be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

Thus, aspects of the invention can be implemented, for example, by one or more appropriately programmed general purpose computers, such as, for example, servers, mobile devices, or personal computers, located at one or more of the entities in the figures, as well as within the payment network 2008 and/or payment system 1006. Such computers can be interconnected, for example, by one or more of payment network 2008, another VPN, the Internet, a local area and/or wide area network (LAN and/or WAN), via an EDI layer, and so on. Note that element 2008 represents both the network and its operator. The computers can be programmed, for example, in compiled, interpreted, object-oriented, assembly, and/or machine languages, for example, one or more of C, C++, Java, Visual Basic, COBOL, Assembler, Structured Query Language (SQL), and the like (an exemplary and non-limiting list), and can also make use of, for example, Extensible Markup Language (XML), known application programs such as relational database applications (e.g., IBM DB2® software available from International Business Machines Corporation, Armonk, N.Y., US; SAS® software available from SAS Institute, Inc., Cary, N.C., US), spreadsheets (e.g., MICROSOFT EXCEL® software available from Microsoft Corporation, Redmond, Wash., US), and the like. The computers can be programmed to implement the logic and/or data flow depicted in the figures. In some instances, messaging and the like may be in accordance with the International Organization for Standardization (ISO) Specification 8583 Financial transaction card originated messages—Interchange message specifications and/or the ISO 20022 or UNIFI Standard for Financial Services Messaging, also incorporated herein by reference in its entirety for all purposes. In one or more embodiments, some messages may be in accordance with NACHA Automated Clearing House (ACH) rules and regulations.

Although illustrative embodiments of the invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for automating sequential electronic payments, in a scenario where a buyer purchases at least one of goods and services from a seller via an intermediary, said method comprising the steps of:
obtaining, at at least one of said intermediary and a third party, an indication that payment to said intermediary from said buyer is appropriate;
responsive to said indication, said at least one of said intermediary and said third party initiating a pull payment, via a payment card network, for an on-file payment card account number of said buyer;
responsive to success of said pull payment, said at least one of said intermediary and said third party initiating a push payment to said seller.

2. The method of claim 1, wherein said step of initiating said push payment comprises said at least one of said intermediary and said third party making a single-use virtual payment card number available to said seller.

3. The method of claim 2, wherein said at least one of said intermediary and said third party makes said single-use virtual payment card number available to said seller by sending said single-use virtual payment card number to said seller by e-mail.

4. The method of claim 2, wherein said at least one of said intermediary and said third party makes said single-use virtual payment card number available to said seller by advising said seller to log onto a secure web portal.

5. The method of claim 1, wherein said step of initiating said push payment comprises said at least one of said intermediary and said third party enabling said seller to make a limited charge against a reusable payment card account number.

6. The method of claim 1, wherein said step of initiating said push payment comprises said at least one of said intermediary and said third party initiating a special payment transaction over said payment card network wherein said seller has a payment card account in which said seller can receive payments via said special payment transaction over said payment card network.

7. The method of claim 1, further comprising the additional steps of:
issuing said on-file payment card account number to said buyer;
providing a server of said at least one of said intermediary and said third party with access to a virtual card number generator;
provisioning said server of said at least one of said intermediary and said third party with software to enable said pull payment; and
providing a server of said seller with software to enable said push payment.

8. The method of claim 1, wherein said obtaining, at said at least one of said intermediary and said third party, of said indication that said payment to said intermediary from said buyer is appropriate, comprises said buyer authorizing said payment to said intermediary from said buyer.

9. The method of claim 8, wherein said buyer authorizing said payment to said intermediary from said buyer comprises said buyer assenting via a secure web portal of said at least one of said intermediary and said third party.

10. The method of claim 9, further comprising providing a system, wherein the system comprises distinct software modules, each of the distinct software modules being embodied on a non-transitory computer-readable storage medium, and wherein the distinct software modules comprise a portal module and a work flow engine module;
wherein:
said buyer assenting via said secure web portal is carried out by said portal module executing on at least one hardware processor, said portal module executing on said at least one hardware processor forming at least a portion of said secure web portal; and
said at least one of said intermediary and said third party initiating said pull payment and said at least one of said intermediary and said third party initiating said push payment are carried out, at least in part, by said work flow engine module executing on said at least one hardware processor.

11. The method of claim 1, wherein said obtaining, at said at least one of said intermediary and said third party, of said indication that said payment to said intermediary from said buyer is appropriate, comprises at least obtaining an indication that an outside agency certifying that said at least one of goods and services meet a required standard.

12. The method of claim 11, further comprising providing a system, wherein the system comprises distinct software modules, each of the distinct software modules being embodied on a non-transitory computer-readable storage medium, and wherein the distinct software modules comprise an external rating system interface module and a work flow engine module;
wherein:
said obtaining of said indication that said outside agency certifies that said at least one of goods and services meet a required standard is carried out by said external rating system interface module executing on at least one hardware processor; and
said at least one of said intermediary and said third party initiating said pull payment and said at least one of said intermediary and said third party initiating said push payment are carried out, at least in part, by said work flow engine module executing on said at least one hardware processor.

13. The method of claim 1, wherein said obtaining, at said at least one of said intermediary and said third party, of said indication that said payment to said intermediary from said buyer is appropriate, comprises elapse of a period of time previously agreed to by said intermediary and said buyer.

14. The method of claim 13, further comprising providing a system, wherein the system comprises distinct software modules, each of the distinct software modules being embodied on a non-transitory computer-readable storage medium, and wherein the distinct software modules comprise a timer-calendar module and a work flow engine module;
wherein:
said obtaining of said indication that said payment to said intermediary from said buyer is appropriate comprises said elapse of said period of time being calculated by said timer-calendar module executing on at least one hardware processor; and
said at least one of said intermediary and said third party initiating said pull payment and said at least one of said intermediary and said third party initiating said push payment are carried out, at least in part, by said work flow engine module executing on said at least one hardware processor.

15. The method of claim 1, wherein said obtaining, at said at least one of said intermediary and said third party, of said indication that said payment to said intermediary from said buyer is appropriate, comprises at least presentment of an associated invoice in accordance with a prior agreement.

16. The method of claim 15, further comprising providing a system, wherein the system comprises at least one distinct software module embodied on a non-transitory computer-readable storage medium, and wherein the at least one distinct software modules comprise a work flow engine module;
wherein said at least one of said intermediary and said third party initiating said pull payment and said at least one of said intermediary and said third party initiating said push payment are carried out, at least in part, by said work flow engine module executing on said at least one hardware processor.

17. The method of claim 1, wherein said step of at least one of said intermediary and said third party initiating said push payment to said seller comprises said at least one of said intermediary and said third party providing payment information directly to said seller.

18. The method of claim 1, wherein said step of at least one of said intermediary and said third party initiating said push payment to said seller comprises said at least one of said intermediary and said third party providing payment information directly to an acquirer of said seller.

19. An apparatus for automating sequential electronic payments, in a scenario where a buyer purchases at least one of goods and services from a seller via an intermediary, said apparatus comprising:
means for obtaining, at at least one of said intermediary and a third party, an indication that payment to said intermediary from said buyer is appropriate;
means for, responsive to said indication, said at least one of said intermediary and said third party initiating a pull payment, via a payment card network, for an on-file payment card account number of said buyer;
means for, responsive to success of said pull payment, said at least one of said intermediary and said third party initiating a push payment to said seller.

20. An article of manufacture comprising a computer program product for automating sequential electronic payments, in a scenario where a buyer purchases at least one of goods and services from a seller via an intermediary, said computer program product comprising:
a tangible computer-readable recordable storage medium, storing in a non-transitory manner computer readable program code, the computer readable program code comprising:
computer readable program code configured to obtain, at at least one of said intermediary and a third party, an indication that payment to said intermediary from said buyer is appropriate;
computer readable program code configured to, responsive to said indication, trigger said at least one of said intermediary and said third party to initiate a pull payment, via a payment card network, for an on-file payment card account number of said buyer;
computer readable program code configured to, responsive to success of said pull payment, trigger said at least one of said intermediary and said third party to initiate a push payment to said seller.

21. An apparatus for automating sequential electronic payments, in a scenario where a buyer purchases at least one of goods and services from a seller via an intermediary, said apparatus comprising:
a memory;
at least one processor operatively coupled to said memory; and
a persistent storage device operatively coupled to said memory and storing in a non-transitory manner instructions which when loaded into said memory cause said at least one processor to be operative to:
obtain, at at least one of said intermediary and a third party, an indication that payment to said intermediary from said buyer is appropriate;
responsive to said indication, trigger said at least one of said intermediary and said third party to initiate a pull payment, via a payment card network, for an on-file payment card account number of said buyer;
responsive to success of said pull payment, trigger said at least one of said intermediary and said third party to initiate a push payment to said seller.

22. The apparatus of claim 21, wherein:
said instructions on said persistent storage device comprise distinct software modules, said distinct software modules in turn comprising a portal module and a work flow engine module;
said at least one processor is operative to obtain, at said at least one of said intermediary and said third party, said indication that said payment to said intermediary from said buyer is appropriate, via said buyer authorizing said payment to said intermediary from said buyer by assenting via a secure web portal of said at least one of said intermediary and said third party, said portal module executing on said at least one processor comprising at least a portion of said secure web portal; and
said work flow engine module comprises said instructions which trigger said at least one of said intermediary and said third party to initiate said pull payment and said push payment.

23. The apparatus of claim 22, wherein said work flow engine module resides on a server of said intermediary and wherein said at least one processor comprises a processor of said server.

24. The apparatus of claim 21, wherein:
said instructions on said persistent storage device comprise distinct software modules, said distinct software modules in turn comprising a portal module and a work flow engine module;
said at least one processor is operative to obtain, at said at least one of said intermediary and said third party, said indication that said payment to said intermediary from said buyer is appropriate, via said intermediary self-certifying, via a secure web portal, in accordance with terms previously agreed to by said intermediary and said buyer, said portal module executing on said at least one processor comprising at least a portion of said secure web portal; and
said work flow engine module comprises said instructions which trigger said at least one of said intermediary and said third party to initiate said pull payment and said push payment.

25. The apparatus of claim 24, wherein said work flow engine module resides on a server of said intermediary and wherein said at least one processor comprises a processor of said server.

26. The apparatus of claim 21, wherein:
said instructions on said persistent storage device comprise distinct software modules, said distinct software modules in turn comprising a timer-calendar module and a work flow engine module;
said at least one processor is operative to obtain, at said at least one of said intermediary and said third party, said indication that said payment to said intermediary from said buyer is appropriate, via elapse of a period of time previously agreed to by said intermediary and said buyer, said elapse of said period of time being calculated by said timer-calendar module executing on said at least one processor; and
said work flow engine module comprises said instructions which trigger said at least one of said intermediary and said third party to initiate said pull payment and said push payment.

27. The apparatus of claim 26, wherein said work flow engine module resides on a server of said intermediary and wherein said at least one processor comprises a processor of said server.
